(19) United States
(12) Patent Application Publication
(10) Pub. No.: US 2015/0193892 A1
(43) Pub. Date: Jul. 9, 2015

(54) PARCEL DATA COLLECTION AND ANALYSIS SYSTEMS, DEVICES, AND METHODS

(71) Applicant: X STREAM INFO, LLC, Lake Stevens, WA (US)

(72) Inventor: Kendall Bond, San Diego, CA (US)

(21) Appl. No.: 14/590,771

(22) Filed: Jan. 6, 2015

Related U.S. Application Data
(60) Provisional application No. 61/924,118, filed on Jan. 6, 2014.

(51) Int. Cl. G06Q 50/16; G06Q 30/08

(52) U.S. Cl. CPC G06Q 50/16; G06Q 30/08

(57) ABSTRACT

Distressed real property is offered for sale at real property parcel auction events. Such distressed real property presents an investment opportunity. The parcels available at real property parcel auction events are often identified using a primary identifier assigned by a taxation authority or municipal utility. Such identifiers can be autonomously retrieve, collect, and analyze primary parcel specific information. One or more secondary identifiers such as a street address may be autonomously extracted from the primary parcel specific information. Using the one or more secondary identifiers, secondary parcel specific information may be obtained. The retrieved primary and secondary parcel specific information is collected, organized, and analyzed by the parcel data collection and analysis system. The parcel data collection and analysis system then presents the collected, organized and analyzed primary and secondary parcel specific information in tabbed or tabular user interface formats.

### BACKGROUND

1. Field

This disclosure generally relates to digital data collection and analysis systems and more particularly to distressed real property parcel data collection and analysis systems.

2. Description of the Related Art

All states have laws that permit local governments to sell property through a tax lien foreclosure process if the owner falls behind on property taxes or other municipal charges. These laws place a lien on the property for the amount of past due taxes. A tax lien almost always has first priority over all other liens, including mortgages. If the taxes remain unpaid, municipalities auction the lien or the property to private purchasers and investors. Prior to foreclosure, most owners have a right to redeem their property by paying the tax sale purchaser the purchase price plus interest, penalties, and costs within the time period allowed by statute. The failure to redeem leads to foreclosure.

These laws serve an important purpose in ensuring that local governments recover tax revenue needed to provide essential government services. However, states rarely update these laws and this allows an investor an opportunity unseen in other areas of the real estate market or any industry for that matter. For example, the interest and penalties homeowners must pay to redeem their property after a tax sale are set by laws that were enacted decades ago in most states and do not reflect the current cost of funds. Tax sale purchasers are entitled to a return on investment, but these laws produce profits in many states at a much higher rate than ordinary investments. Although banks currently provide interest on savings accounts at less than 1 percent, many states permit tax sale purchasers to recover interest at rates of 18 percent or more, even as high as 20-50 percent.

Most jurisdictions follow three sequential steps to foreclose on properties delinquent on taxes: 1) imposition of a lien and notification of a pending tax sale; 2) sale of the tax lien or tax deed; and, 3) final enforcement of the lien or deed through foreclosure. The final step generally results in a transfer of the property to the tax sale purchaser and eliminates all ownership interests in the property. In between the first and final stages, homeowners and lenders typically have a redemption period during which they can remove the lien and reacquire full ownership of the property by paying the taxes owed, plus interest, penalties, attorney fees and costs. In some states, this period to redeem occurs prior to the tax sale and is more accurately described as a right to “cure” the defect in the title. In most states, however, the redemption period comes after the tax sale.

In the first stage, the tax obligation becomes a lien on the property if the taxes are not paid within a certain time period. Often this is the first day of the year following the year in which the tax is assessed. The creation of a tax lien generally occurs automatically by operation of state statute. A tax lien typically has first priority over all other liens, including mortgages, whether created before or after the tax lien. These laws have been upheld on the grounds that priority is essential to the government collecting the revenue necessary to conduct its business. There are three different approaches taxing authorities use to dispose of tax liens during the second “tax sale” stage following nonpayment of taxes by homeowners: auction, negotiated bulk sale, and securitization. The auction method was the only method used until the 1990s, and it remains the most common tax sale procedure. Following efforts to privatize government functions in other areas, some local governments have used bulk sales of tax liens as a means to shift tax collection responsibility to private entities. This same goal has been achieved by a small number of local governments through the pooling and sale of tax liens in a securitization process similar to that used in the mortgage industry for mortgage-backed securities.

Municipalities exclusively used the auction method prior to 1993. As mentioned earlier, property taxes which remain unpaid for a specified time period become a lien on the property automatically by operation of law. If a tax lien is not discharged, the taxing authority will generally initiate a tax sale procedure that may result in the sale of the property at auction. In some states, there is a specified “waiting period” before the municipality may proceed with a tax sale. The sale process is usually commenced when the taxing authority prepares a list of delinquent taxes, identifying the taxpayer, property, and amount of taxes due. The list is typically recorded and published in the local newspaper. All states also require some form of notice to the taxpayer before the sale. An order of sale or directive from the local municipality or taxing authority then issues commanding the appropriate government official to conduct the sale. The initial sale in most jurisdictions takes place without any involvement of a court.

In some jurisdictions, the property itself is sold at the tax sale auction. After the sale is completed, the taxing authority provides the tax sale purchaser with a deed to the property. The purchaser becomes the new owner of the property, either immediately following the sale or after a redemption period expires. Because the purchaser typically receives a tax deed to the property, the tax sale procedure in such states is often referred to as a “tax deed” sale. The proceeds from the sale are used to satisfy the outstanding tax bill and pay any costs of the sale to the municipality. Any surplus above the tax obligation and costs is paid to the former owner or to junior recorded lienholders if required by law.

In other jurisdictions, something less than full title to the property is initially sold. In these jurisdictions the taxing authority provides the tax sale purchaser with a “certificate” that gives the purchaser the right at some later point to foreclose the tax lien. Because the purchaser typically receives a tax lien certificate, the tax sale procedure in such states may be referred to as a “tax lien certificate” sale. For example, in Illinois, the purchaser at the tax sale receives a certificate of purchase upon payment of the delinquent taxes and costs. After the expiration of the period of redemption, the certificate holder may obtain the tax deed by initiating a court action. The taxing authority receives the amount of the outstanding lien; the right to collect interest and penalties on the outstanding tax obligation transfers to the lien purchaser.

Although rare, in some jurisdictions there is no sale at all. The taxing authority simply executes on its lien by taking the property. For example, in New Hampshire, unpaid taxes become a lien against the property after expiration of a statutory period. The taxpayer and others with a recorded interest in the property are given notice of the lien together with a redemption period of two years and one day to pay off the lien. If the lien is not paid, the town takes the property free and clear of all liens. Once the property is acquired by the taxing authority or local government, state law generally provides a procedure for final disposition of the property. In Minnesota, the property is initially forfeited to the state for unpaid taxes and fees and then sold at public auction to the highest bidder for not less than the appraised value.

Unlike traditional auction sales and mortgage foreclosure sales, potential buyers at a tax sale in many states do not bid based on the value of the property because the property is sold for the amount of unpaid taxes, interest, fees, penalties, and related costs. In these states that do not permit the property to be sold for more than the unpaid tax debt, there is generally no competitive, value-based bidding such as might exist at other auction sales. However, when there is more than one bidder on the property, states generally have devised some proxy for competitive bidding through three primary methods: the percentage ownership method, the interest rate method, and the overbid method.

The percentage ownership method assigns the lien to the bidder who accepts the smallest proportional share or fraction of the total tax sale interest in the property that is sold. For example, in a tax deed sale in which there is bidding, the sale may result in the purchaser acquiring a 10 percent interest in the property. If the property is not redeemed by the homeowner and the tax deed is foreclosed, the homeowner would still retain a 90% interest in the property.

The interest rate method assigns the lien to the bidder who accepts the lowest rate of interest due upon redemption in addition to the unpaid taxes. For example, state law may set the maximum interest to be paid by the homeowner upon redemption at 18 percent, but the winning bid may be awarded to the potential purchaser who is willing to accept redemption interest at the rate of 14 percent.

The overbid method assigns the lien certificate or deed to the bidder who pays the highest additional amount after paying the unpaid taxes on the property. For example, if the minimum bid at the auction sale is $2,500 (which represents the delinquent taxes and costs) for a home valued at $100,000, and the highest bid at the sale is $10,000, the purchaser will obtain the home itself or a lien certificate for the property in return for payment of $10,000 to the taxing authority. Any surplus above the tax obligation and costs of sale (which would be $7,500 in this example) is usually paid to the former owner or to junior recorded lienholders if required by law.

A negotiated bulk sale is the second procedure used by taxing authorities to sell off tax liens. This involves the pooling of delinquent tax liens which are then sold as a package at a discount to a private entity. The local government relinquishes its ability and obligation to collect on the tax liens. The private entity essentially steps into the shoes of the taxing authority and becomes the owner of the liens. It then services the liens, communicates with property owners, and keeps any funds paid on the past-due taxes, interest, and penalties.

The final method available to taxing authorities is similar to a bulk sale but is done through the securitization process. Officials in Jersey City, N.J. pioneered this method in 1993, and it initially became popular with large cities having cash-flow problems. Major cities like New Haven, Atlanta, New York, Washington D.C., and Philadelphia have also completed similar securitization transactions on their property owners' tax debt. In most securitization cases, the municipality creates a trust which purchases the tax liens at a discount. After the purchase, the trust issues bonds backed by the liens. The taxing authority receives a portion of the proceeds from the bond sale. Typically, the price of the bonds issued is less than the face value of the tax liens. Although the discounted sale price results in reduced receivables, securitizations can be beneficial to a taxing authority because they receive payment for a portion of the delinquent taxes right away and can avoid collection risks and transaction costs. Moreover, some securitization deals are structured so that the taxing authority retains a residual interest in the tax liens that are sold and can therefore recover any payments made in excess of the principal and interest due to bondholders. In other cases, the municipality may securitize its tax receivables without actually selling the tax liens at auction. Servicers manage the pool of liens or receivables purchased by the trust, collect the delinquent taxes, and handle foreclosure of the liens if the property is not redeemed.

Another form of securitization involves investment firms that purchase large numbers of tax liens certificates at tax auctions and then securitize the liens or certificates they have purchased. The municipality receives its money for the full face value of the lien up front at the sale, depending on the bidding method, and the banks or hedge funds purchasing the liens then bundle large numbers of liens to sell to investors.

Full rights to the property sold at a tax sale generally do not pass immediately to the purchaser. Rather, the purchaser acquires an interest in the property subject to redemption by the former owner. The former owner in most states has a right to redeem the property by paying to the purchaser the purchase price plus interest, penalties, and costs within the time period allowed by statute. If the former owner does not redeem within the prescribed period, the purchaser acquires title to the property free and clear of all liens created prior to the sale. In some states the deed is issued to the purchaser automatically upon expiration of the redemption period; in other states a tax sale purchaser must apply for the deed. This may involve simply making a request to the local taxing agency or it may require the purchaser to bring a foreclosure action to cut off the right of redemption or an action to quiet title.

Judicial supervision over the tax sale process varies considerably from state to state. In approximately half of the states, particularly those in which the redemption right terminates automatically, there is no court oversight of the tax sale process. Similar to non-judicial mortgage foreclosure proceedings, there is no judge reviewing the process to ensure that the law has been followed.

### BRIEF SUMMARY

Websites operated by municipalities such as cities and counties provide distressed real property auction information. A unique identifier (e.g., a “parcel ID” or similar) assigned by the taxing authority uniquely identifies some or all of the taxable real property within the jurisdiction. Thus, the distressed real properties included in a particular auction are identified by the unique identifier assigned by the taxing authority rather than the more colloquial address or longitude/latitude with which most are familiar. While much information associated with a particular real property may be available from the Website operated by the taxing authority, additional information may be available from other sources such as one or more commercial websites.

A method of retrieving and analyzing parcel data from a collection of data sources and associated with parcels offered at a number of auction events may be summarized as including autonomously retrieving by at least one processor a number of unique primary identifiers, each logically associated with a parcel offered for purchase at an auction event and located in a defined geographic jurisdiction; for each of the number of primary identifiers retrieved by the at least one processor, autonomously retrieving by the at least one processor primary parcel specific information from a number of networked primary data sources, each of the number of networked primary data sources including primary parcel specific information associated with the respective parcel; and storing the retrieved primary parcel specific information in one or more data stores included in at least one nontransitory storage media communicably coupled to the at least one processor, the retrieved primary parcel specific information logically associated with a single parcel indexed across the one or more data stores using the primary identifier associated with the respective parcel.

Autonomously retrieving by at least one processor a number of unique primary identifiers may include receiving by the at least one processor via a communicably coupled input device at least one input indicative of a selection of the auction event; responsive to the receipt of the input indicative of the selection of the auction event, autonomously retrieving by the at least one processor the number of unique primary identifiers, each of the number of unique primary identifiers logically associated with respective parcels offered for purchase at the selected auction event and located in the defined geographic jurisdiction. Receiving by the at least one processor at least one input indicative of a selection of the auction event may include receiving by the at least one processor via a communicably coupled input device at least one input that includes data indicative of a selection of at least one auction event via a graphical user interface that includes at least a calendar on which the auction events are displayed. Receiving by the at least one processor at least one input that includes data indicative of a selection of at least one auction event presented on a calendar graphical user interface may include receiving by the at least one processor at least one input that includes data indicative of a selection of at least one distressed real property parcel auction event displayed via the graphical user interface that includes at least a calendar. Autonomously retrieving by the at least one processor a number of unique primary identifiers, each logically associated with a parcel offered for purchase at the selected auction event may include autonomously retrieving by the at least one processor a number of unique real property parcel identifiers (“parcel IDs”), each logically associated with a distressed real property parcel offered for purchase at the auction event. Autonomously retrieving by the at least one processor primary parcel specific information from a number of networked primary data sources may include autonomously retrieving by the at least one processor primary parcel specific information from a number of networked primary data sources, the number of networked primary data sources including at least one of a source administered by: a Mortgage Electronic Records System (“MERS”); a Federal Emergency Management Authority (“FEMA”); a tax assessor for the geographical jurisdiction; or a tax collector for the geographical jurisdiction. Autonomously retrieving by the at least one processor primary parcel specific information from a number of primary data sources may include autonomously retrieving by the at least one processor primary parcel specific information from the number of primary data sources, the primary parcel specific information including at least one of: an assessed parcel land value; an assessed parcel improvements value; the date and/or amount of prior taxes paid on the parcel; or the date and/or amount of current taxes due on the parcel. The method may further include for each of at least some of the number of primary identifiers retrieved by the at least one processor, autonomously retrieving by the at least one processor at least one secondary identifier associated with the respective parcel from at least one of the number of networked primary data sources; for each of the number of secondary identifiers retrieved by the at least one processor, autonomously retrieving by the at least one processor secondary parcel specific information from a number of networked secondary data sources, each of the number of networked secondary data sources including at least secondary parcel specific information associated with the respective parcel; and storing in at least one nontransitory storage media communicably coupled to the at least one processor the retrieved secondary parcel specific information, the retrieved secondary parcel specific information logically associated with the primary identifier associated with the respective parcel. Autonomously retrieving by the at least one processor at least one secondary identifier logically associated with the respective parcel from at least one of the number of networked primary data sources may include autonomously retrieving by the at least one processor at least one secondary identifier representative of at least one of: a street address logically associated with the parcel or a unique set of geolocation coordinates logically associated with the parcel from at least one of the number of primary data sources. Autonomously retrieving by the at least one processor secondary parcel specific information from a number of networked secondary data sources may include autonomously retrieving by the at least one processor secondary parcel specific information from a number of networked secondary data sources including at least one Website. Wherein autonomously retrieving by the at least one processor secondary parcel specific information from a number of networked secondary data sources may include autonomously retrieving by the at least one processor secondary parcel specific information that includes at least one of: comparable parcel sales, a real-estate heat map, estimated parcel values, parcel owner information, parcel rental income potential, or prior parcel sale information.

A system of retrieving parcel data from a collection of data sources and related to parcels offered at a number of auction events may be summarized as including at least one processor; at least one user input device communicably coupled to the at least one processor; at least one user output device communicably coupled to the at least one processor; and at least one nontransitory storage media communicably coupled to the at least one processor and including one or more machine executable instruction sets that, when executed by the at least one processor, provide a dedicated parcel auction analysis and reporting system and which cause the at least one processor to: autonomously retrieve a number of unique primary identifiers, each associated with a parcel offered for purchase at an auction event and located in a defined geographic jurisdiction; for each of the number of unique primary identifiers, autonomously retrieve from a number of network primary data sources primary parcel specific information associated with the respective unique primary identifier; and store the retrieved primary parcel specific information in one or more data stores included in the at least one nontransitory storage media, the retrieved primary parcel specific information associated with a parcel indexed across the one or more data stores using the primary identifier logically associated with the respective parcel.

The one or more machine executable instruction sets that cause the at least one processor to autonomously retrieve a number of unique primary identifiers may further cause the at least one processor to: receive at least one input indicative of a selection of the auction event via the at least one input device; responsive to the receipt of the input provided via the at least one input device, autonomously retrieve the number of unique primary identifiers, each of the number of unique primary identifiers associated with a parcel offered for purchase at an auction event and located in a defined geographic jurisdiction. The one or more machine executable instruction sets that cause the at least one processor to receive at least one input indicative of a selection of the auction event via the at least one input device may further cause the at least one processor to: cause the processor to generate data representative of an output for presentation on the at least one communicably coupled output device, the data representative of the output including a graphical user interface that includes at least a calendar on which the auction events are displayed; and receive via the calendar displayed on the graphical user interface the at least one input indicative of a selection of the auction event. The one or more machine executable instruction sets that cause the at least one processor to generate data representative of an output for presentation by the at least one communicably coupled output device may further cause the at least one processor to: generate data representative of an output for presentation by the at least one communicably coupled output device, the data representative of the output including at least a graphical user interface that includes at least a calendar on which a number of distressed parcel auction events are displayed. The one or more machine executable instruction sets that cause the at least one processor to autonomously retrieve a number of unique primary identifiers, each of the unique primary identifiers associated with a parcel offered for purchase at an auction event, may further cause the at least one processor to: autonomously retrieve a number of unique parcel identifiers (“parcel IDs”), each of the parcel IDs associated with a distressed real property parcel offered for purchase at one of the number of distressed parcel auction events. The one or more machine executable instruction sets that cause the at least one processor to autonomously retrieve from a number of network primary data sources primary parcel specific information associated with the respective primary identifier may further cause the at least one processor to: for each primary identifier, autonomously retrieve primary parcel specific information associated with the respective primary identifier from the number of network primary data sources including at least one of a source administered by: a Mortgage Electronic Records System (“MERS”); a Federal Emergency Management Authority (“FEMA”); a tax assessor for the geographical jurisdiction; or a tax collector for the geographical jurisdiction. The one or more machine executable instruction sets that cause the at least one processor to autonomously retrieve from a number of network primary data sources primary parcel specific information associated with the respective primary identifier may further cause the at least one processor to: autonomously retrieve from a number of primary data sources primary parcel specific information including at least one of: an assessed parcel land value; an assessed parcel improvements value; the date and/or amount of prior taxes paid on the parcel; or the date and/or amount of current taxes due on the parcel. The one or more machine executable instruction sets may further cause the at least one processor to: autonomously identify at least one secondary identifier included in the primary parcel specific information retrieved from the number of network primary data sources using at least some of the number of primary identifiers; logically associate the at least one secondary identifier with the respective primary identifier associated with the primary parcel specific information; for each secondary identifier, autonomously retrieve secondary parcel specific information from some or all of a number of network secondary data sources; and storing in the at least one nontransitory storage media the retrieved secondary parcel specific information, the stored secondary parcel specific information logically associated with the respective primary identifier associated with the primary parcel specific information. The one or more machine executable instruction sets that cause the at least one processor to autonomously identify at least one secondary identifier included in the primary parcel specific information retrieved from the number of network primary data sources may further cause the at least one processor to: autonomously identify at least one secondary identifier included in the primary parcel specific information retrieved from the number of network primary data sources, the at least one secondary identifier including data representative of at least one of: a street address associated with the parcel or a unique set of geolocation coordinates associated with the parcel. The one or more machine executable instruction sets that cause the at least one processor to autonomously retrieve secondary parcel specific information from some or all of a number of network secondary data sources may further cause the at least one processor to: autonomously retrieve secondary parcel specific information from some or all of a number of network secondary data sources including at least one Website. The one or more machine executable instruction sets that cause the at least one processor to autonomously retrieve secondary parcel specific information from some or all of a number of network secondary data sources may further cause the at least one processor to: autonomously retrieve secondary parcel specific information that includes data representative of at least one of: comparable parcel sales, a real-estate heat map, estimated parcel values, parcel owner information, parcel rental income potential, or prior parcel sale information.

A method of presenting parcel data obtained from a collection of data sources and related to parcels offered at one or more auction events may be summarized as including autonomously retrieving a number of unique primary identifiers by at least one processor from a first number of network connected devices, each of the number of primary identifiers logically associated with a respective parcel located in a defined geographic jurisdiction and offered for purchase at an auction event; for each of the retrieved unique primary identifiers, autonomously retrieving primary parcel specific information from at least some of a number of networked primary data sources by the at least one processor and logically associating the retrieved primary parcel specific information with the respective unique primary identifier; generating output data in a first output format by the at least one processor for presentation via at least one communicably coupled output device, the first output format including a number of tabbed records logically associated with a primary identifier, the tabbed records including the retrieved primary parcel specific information logically associated with the respective unique primary identifier.

Autonomously retrieving a number of unique primary identifiers by at least one processor may include receiving by the at least one processor via a communicably coupled input device at least one input indicative of a selection of at least one of a number of auction events; and responsive to the receipt of the input indicative of the selection of at least one of the number of auction events, autonomously retrieving the number of unique primary identifiers from a first number of network connected devices by the at least one processor. Receiving at least one input indicative of a selection of at least one of a number of auction events may include generating output data for presentation via the at least one output device, the output data including a graphical user interface that includes at least a calendar on which each of the number of auction events are logically associated with a respective, selectable, auction event icon; and receiving the at least one input indicative of a selection of at least one of the auction event icons present on the graphical user interface. Generating output data including a graphical user interface that includes at least a calendar on which each of the number of auction events are logically associated with a respective, selectable, auction event icon may include generating output data including a graphical user interface that includes at least a calendar on which each of the number of auction events correspond to distressed real property auction events, and each of the distressed real property auction events are logically associated with a respective, selectable, distressed real property auction event icon. Autonomously retrieving a number of unique primary identifiers from a first number of network connected devices may include autonomously retrieving a number of unique parcel identifiers (“parcel IDs”), each logically associated with a distressed real property parcel offered for purchase at a distressed real property auction event from the first number of network connected devices. Autonomously retrieving primary parcel specific information from at least some of a number of networked primary data sources may include autonomously retrieving primary parcel specific information from at least some of a number of networked primary data sources, including at least one of the following networked primary data sources: a Mortgage Electronic Records System (“MERS”); a Federal Emergency Management Authority (“FEMA”); a tax assessor for the geographical jurisdiction; or a tax collector for the geographical jurisdiction. Autonomously retrieving primary parcel specific information from at least some of a number of networked primary data sources may include autonomously retrieving primary parcel specific information including at least one of: an assessed parcel land value; an assessed parcel improvements value; the date and/or amount of prior taxes paid on the parcel; or the date and/or amount of current taxes due on the parcel. The method may further include Identifying by the at least one processor at least one secondary identifier included in at least some of the primary parcel specific information retrieved from the number of networked primary data sources; logically associating the at least one secondary identifier with the respective primary identifier by the at least one processor; for each of the identified secondary identifiers, autonomously retrieving by the at least one processor secondary parcel specific information from at least some of a number of networked secondary data sources and logically associating by the at least one processor the retrieved secondary parcel specific information with the unique primary identifier logically associated with the respective secondary identifier; generating by the at least one processor output data in the first output format for presentation via the at least one output device, the first output format including a number of tabbed records logically associated with a primary identifier, the tabbed records including: data representative of the primary parcel specific information autonomously retrieved from the at least some of the number of networked primary data sources and logically associated with the respective unique primary identifier; and data representative of the secondary parcel specific information autonomously retrieved from the at least some of the number of networked secondary data sources and logically associated with the respective unique primary identifier. Autonomously retrieving by the at least one processor secondary parcel specific information from at least some of a number of networked secondary data sources may include autonomously retrieving by the at least one processor secondary parcel specific information from at least some of a number of networked secondary data sources including at least one Website. Autonomously retrieving by the at least one processor secondary parcel specific information from at least some of a number of networked secondary data sources may include autonomously retrieving by the at least one processor secondary parcel specific information from at least some of a number of networked secondary data sources, the secondary parcel specific information including data representative of at least one of: comparable parcel sales, a real-estate heat map, estimated parcel values, parcel owner information, parcel rental income potential, or prior parcel sale information. The method may further include receiving by the at least one processor at least one input indicative of a selection of a second output format via the at least one input device; responsive to the receipt of the input indicative of the selection of the second output format by the at least one processor, generating by the at least one processor output data in the second output format for presentation via the at least one output device, the second output format including a table populated with retrieved primary parcel specific information logically associated with some or all of the number of unique primary identifiers. The method may further include receiving by the at least one processor input data indicative of at least one primary parcel specific information filter via the at least one input device; responsive to the receipt of input data indicative of at least one primary parcel specific information filter, filtering the primary parcel specific information by the at least one processor; and generate output data in the second output format including a table populated with retrieved primary parcel specific information logically associated with some or all of the number of unique primary identifiers and filtered using the at least one primary parcel specific information filter. The method may further include receiving by the at least one processor at least one input indicative of a selection of a second output format via the at least one input device; responsive to the receipt of the input indicative of the selection of the second output format, generating by the at least one processor output data in the second output format for presentation via the at least one output device, the second output format including a table populated with: autonomously retrieved primary parcel specific information logically associated with some or all of the number of unique primary identifiers; and autonomously retrieved secondary parcel specific information logically associated with some or all of the number of unique primary identifiers. The method may further include receiving by the at least one processor via the at least one input device input data indicative of at least one of: at least one primary parcel specific information filter; and at least one secondary parcel specific information filter; responsive to the receipt of the input data indicative of at least one of the at least one primary parcel specific information filter or the at least one secondary parcel specific information filter, filtering by the at least one processor the respective primary parcel specific information or secondary parcel specific information; and generating by the at least one processor output data in the second output format including a table populated with at least one of: the autonomously retrieved primary parcel specific information logically associated with some or all of the number of unique primary identifiers and filtered using the at least one primary parcel specific information filter; and the autonomously retrieved secondary parcel specific information logically associated with some or all of the number of unique primary identifiers and filtered using the at least one secondary parcel specific information filter.

A system to analyze and present parcel data obtained from a collection of data sources and associated with parcels offered at one or more auction events may be summarized as including at least one processor; at least one user input device communicably coupled to the at least one processor; at least one user output device communicably coupled to the at least one processor; and at least one nontransitory storage media communicably coupled to the at least one processor and including one or more machine executable instruction sets that, when executed by the at least one processor, provide a dedicated parcel auction analysis and reporting system and which cause the at least one processor to: autonomously retrieve a number of unique primary identifiers from a first number of network connected devices, each of the number of primary identifiers logically associated with a respective parcel located in a defined geographic jurisdiction and offered for purchase at an auction event; for each of the retrieved unique primary identifiers, autonomously retrieve primary parcel specific information from at least some of a number of networked primary data sources and logically associating the retrieved primary parcel specific information with the respective unique primary identifier; generate output data in a first output format for presentation via the at least one output device, the first output format including a number of tabbed records logically associated with a primary identifier, the tabbed records including the retrieved primary parcel specific information logically associated with the respective unique primary identifier.

The at least one machine executable instruction set that causes the at least one processor to autonomously retrieve a number of unique primary identifiers from a first number of network connected devices may further cause the at least one processor to: receive at least one input indicative of a selection of at least one of a number of auction events via the at least one input device; responsive to the receipt of the input indicative of the selection of at least one of the number of auction events, autonomously retrieve from a first number of network connected devices a number of unique primary identifiers, each of the number of unique primary identifiers associated with a real property parcel located in a defined geographic jurisdiction and offered for purchase at the respective selected auction event. The one or more machine executable instruction sets that cause the at least one processor to receive at least one input indicative of a selection of at least one of a number of auction events may further cause the at least one processor to: generate output data for presentation on the at least one output device, the output data including a graphical user interface that includes at least a calendar on which each of the number of auction events are logically associated with a respective, selectable, auction event icon; and receive the at least one input indicative of a selection of at least one of the auction event icons present on the graphical user interface. The one or more machine executable instruction sets that cause the at least one processor to generate output data including a calendar on which each of the number of auction events are logically associated with a respective, selectable, auction event icon, may further cause the at least one processor to: generate output data including a calendar on which each of the number of auction events correspond to distressed real property auction events, and each of the distressed real property auction events are logically associated with a respective, selectable, distressed real property auction event icon. The one or more machine executable instruction sets that cause the at least one processor to autonomously retrieve a number of unique primary identifiers from a first number of network connected devices may further cause the at least one processor to: autonomously retrieve a number of unique parcel identifiers (“parcel IDs”), each logically associated with a distressed real property parcel offered for purchase at a distressed real property auction event from the first number of network connected devices. The one or more machine executable instruction sets that cause the processor to autonomously retrieve primary parcel specific information from at least some of a number of networked primary data sources may further cause the at least one processor to: autonomously retrieve primary parcel specific information from at least some of a number of networked primary data sources, including at least one networked primary data source administered by: a Mortgage Electronic Records System (“MERS”); a Federal Emergency Management Authority (“FEMA”); a tax assessor for the geographical jurisdiction; or a tax collector for the geographical jurisdiction. The one or more machine executable instruction sets that cause the processor to autonomously retrieve primary parcel specific information from at least some of a number of networked primary data sources may further cause the at least one processor to: autonomously retrieve primary parcel specific information including at least one of: an assessed parcel land value; an assessed parcel improvements value; the date and/or amount of prior taxes paid on the parcel; or the date and/or amount of current taxes due on the parcel. The one or more machine executable instruction sets may further cause the at least one processor to: identify at least one secondary identifier included in at least some of the primary parcel specific information retrieved from the number of networked primary data sources; logically associate the at least one secondary identifier with the respective primary identifier; for each of the identified secondary identifiers, autonomously retrieve secondary parcel specific information from at least some of a number of networked secondary data sources and logically associating the retrieved secondary parcel specific information with the unique primary identifier logically associated with the respective secondary identifier; generate output data in the first output format for presentation via the at least one output device, the first output format including a number of tabbed records logically associated with a primary identifier, the tabbed records including: data representative of the primary parcel specific information autonomously retrieved from the at least some of the number of networked primary data sources and logically associated with the respective unique primary identifier; and data representative of the secondary parcel specific information autonomously retrieved from the at least some of the number of networked secondary data sources and logically associated with the respective unique primary identifier. The one or more machine executable instruction sets that cause the at least one processor to autonomously retrieve secondary parcel specific information from at least some of a number of networked secondary data sources may further cause the at least one processor to: autonomously retrieve secondary parcel specific information from at least some of a number of networked secondary data sources including at least one Website. The one or more machine executable instruction sets that cause the at least one processor to autonomously retrieve secondary parcel specific information from at least some of a number of networked secondary data sources may further cause the at least one processor to: autonomously retrieve secondary parcel specific information from at least some of a number of networked secondary data sources, the secondary parcel specific information including data representative of at least one of: comparable parcel sales, a real-estate heat map, estimated parcel values, parcel owner information, parcel rental income potential, or prior parcel sale information. The at least one machine executable instruction set may further cause the at least one processor to: receive at least one input indicative of a selection of a second output format via the at least one input device; responsive to the receipt of the input indicative of the selection of the second output format by the at least one processor, generate output data in the second output format for presentation via the at least one output device, the second output format including a table populated with retrieved primary parcel specific information logically associated with some or all of the number of unique primary identifiers. The at least one machine executable instruction set may further cause the at least one processor to: receive input data indicative of at least one primary parcel specific information filter via the at least one input device; responsive to the receipt of input data indicative of at least one primary parcel specific information filter by the at least one processor, filter the primary parcel specific information; and generate output data in the second output format including a table populated with retrieved primary parcel specific information logically associated with some or all of the number of unique primary identifiers and filtered using the at least one primary parcel specific information filter. The at least one machine executable instruction set may further cause the at least one processor to: receive at least one input indicative of a selection of a second output format via the at least one input device; responsive to the receipt of the input indicative of the selection of the second output format by the at least one processor, generate output data in the second output format for presentation via the at least one output device, the second output format including a table populated with: autonomously retrieved primary parcel specific information logically associated with some or all of the number of unique primary identifiers; and autonomously retrieved secondary parcel specific information logically associated with some or all of the number of unique primary identifiers. The at least one machine executable instruction set may further cause the at least one processor to: receive via the at least one input device input data indicative of at least one of: at least one primary parcel specific information filter; and at least one secondary parcel specific information filter; responsive to the receipt by the at least one processor of the input data indicative of at least one of the at least one primary parcel specific information filter or the at least one secondary parcel specific information filter, filter the respective primary parcel specific information or secondary parcel specific information; and generate output data in the second output format including a table populated with at least one of: the autonomously retrieved primary parcel specific information logically associated with some or all of the number of unique primary identifiers and filtered using the at least one primary parcel specific information filter; and the autonomously retrieved secondary parcel specific information logically associated with some or all of the number of unique primary identifiers and filtered using the at least one secondary parcel specific information filter.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not intended to convey any information regarding the actual shape of the particular elements, and have been solely selected for ease of recognition in the drawings.

FIG. 1 is a system diagram of an example networked environment, in which an illustrative parcel data collection system obtains distressed real property auction information from a number jurisdiction systems obtains property information from tagged and untagged data sources and presents the compiled and analyzed information to a number of data consumers, according to one illustrated embodiment.

FIG. 2 is a system diagram of an example networked environment, demonstrating a tabbed parcel data collection system user interface that displays data obtained from tag and untagged data sources, indexes the data using a parcel identifier, and presents the compiled and analyzed information to a number of data consumers, according to one illustrated embodiment.

FIG. 3 is a schematic diagram of an example embodiment of a parcel data collection system, according to one illustrated embodiment.

FIG. 4 is a high-level logic flow diagram of a method of collecting and analyzing distressed real property parcel data, according to one illustrated embodiment.

FIG. 5 is a screen capture showing an illustrative calendar interface used to select one or more distressed real property auctions occurring in one or more jurisdictions for analysis, according to one illustrated embodiment.

FIG. 6 is a screen capture showing illustrative Bid Information tabbed parcel data user interface suitable for displaying information associated with a parcel offered for sale at a real property auction event, according to one illustrated embodiment

FIG. 7 is a screen capture showing an illustrative Tax Collector tabbed parcel data user interface suitable for displaying information associated with a parcel offered for sale at a real property auction event, according to one illustrated embodiment.

FIG. 8 is a screen capture showing an illustrative APN Map tabbed parcel data user interface suitable for displaying information associated with a parcel offered for sale at a real property auction event, according to one illustrated embodiment.

FIG. 9 is a screen capture showing an illustrative Google Maps tabbed parcel data user interface suitable for displaying information associated with a parcel offered for sale at a real property auction event, according to one illustrated embodiment.

FIG. 10 is a screen capture showing an illustrative real estate Heat Map tabbed parcel data user interface suitable for displaying information associated with a parcel offered for sale at a real property auction event, according to one illustrated embodiment.

FIG. 11 is a screen capture showing an illustrative Ownership & Encumbrance (O&E) report tabbed parcel data user interface suitable for displaying information associated with a parcel offered for sale at a real property auction event, according to one illustrated embodiment.

FIG. 12 is an illustrative tabular parcel data user interface suitable for displaying parcel data associated with a number of parcel identifiers in columnar format, according to one illustrative embodiment.

FIG. 13 is a logic flow diagram of an illustrative method of retrieving parcel data from jurisdictional authorities via an automated robot using a parcel identifier retrieved from a distressed real property parcel auction, and logically associating the retrieved parcel data with the parcel identifier by the parcel data collection system, according to one illustrated embodiment.

FIG. 14 is a logic flow diagram of an illustrative method of retrieving parcel data from public and/or commercial information sources via an automated robot using a physical location such as an address or geolocation coordinates, and logically associating the retrieved parcel data with the parcel identifier by the parcel data collection system, according to one illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with computing systems including client and server computing systems, as well as networks, including various types of telecommunications networks, have not been shown or described in detail to avoid unnecessarily obscuring descriptions of the embodiments. Details regarding standard user interface navigation (e.g., scrolling through tabular data such as that found in a spreadsheet, navigating through records such as those found in a database, and the like) have not been shown or described in detail to avoid unnecessarily obscuring descriptions of the embodiments. Further, computer or interface functionality such as file saving, printing, searching, Web browser functionality, and the like have not been shown or described in detail to avoid unnecessarily obscuring descriptions of the embodiments.

Unless the context requires otherwise, throughout the specification and claims which follow, the word “comprise” and variations thereof, such as “comprises” and “comprising,” are to be construed in an open, inclusive sense, that is, as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

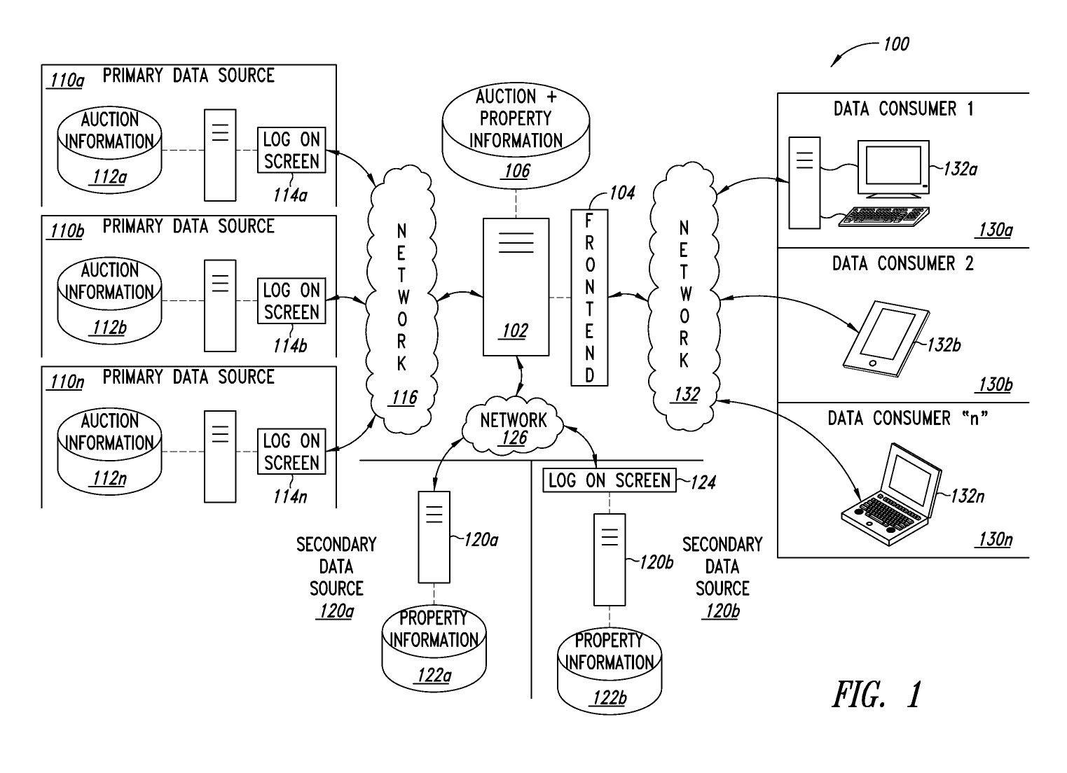

FIG. 1 shows a networked environment 100, in which a parcel data collection and analysis system 102 identifies parcels offered for sale at one or more real property or parcel auction events, retrieves parcel data from a number of networked primary information sources 110a-110n (collectively “primary information sources 110”) and networked secondary information sources 120a-120n (collectively, “secondary information sources 120”), analyzes at least a portion of the retrieved information and provides the collected and analyzed information to one or more data consumers 130. In at least some implementations the parcel auction events may include distressed real property auction events sanctioned or otherwise authorized by local authorities such as taxation authorities, municipal utilities, or the like. Such auction events may for example, be used by the jurisdiction, municipality, or utility to collect on a lien placed against a real property parcel based on an outstanding tax, utility bill, or similar obligation on behalf of the legal property owner.

The parcel data collection and analysis system 102 autonomously retrieves, for example from the parcel auction event Website, a number of primary parcel specific identifiers, each associated with a parcel offered for sale at the parcel auction event. For some or all of the retrieved primary parcel specific identifiers, the parcel data collection and analysis system 102 retrieves primary parcel specific information from the one or more primary information sources 110 communicably coupled to the parcel data collection and analysis system 102 via one or more networks 116. In at least some instances, such primary information sources 110 include one or more electronic data processing and/or data distribution systems owned and/or operated by a governmental jurisdiction (e.g., city and/or county) or municipal utility authority (e.g., municipally owned sewer, water, electric, and/or natural gas). In at least some implementations, the unique primary parcel specific identifier includes a parcel identifier assigned by the jurisdictional taxation authority (e.g., tax assessor, tax collector) and associated with a respective real property parcel.

Using the autonomously retrieved primary parcel specific information, the parcel data collection and analysis system 102 determines at least one secondary parcel specific identifier associated with some or all of the parcels available for purchase at one or more parcel auction events. Such secondary parcel specific identifiers may include, but are not limited to, physical location information such as a street address or geolocation coordinates (e.g., longitude and latitude). For each parcel identified by the parcel data collection and analysis system 102 as having a primary parcel specific identifier and at least one secondary parcel specific identifier, the parcel data collection and analysis system 102 logically associates the primary parcel specific identifier with the identified secondary parcel specific identifiers. Thus, in some instances, some or all parcels available for purchase at a parcel auction event are associated with a Parcel ID (i.e., the primary parcel specific identifier) that is logically associated with a physical address or geolocation coordinates (i.e., secondary parcel specific identifier(s)).

Using a secondary parcel specific identifier logically associated with the parcel, the parcel data collection and analysis system 102 autonomously obtains secondary parcel specific information associated with the respective parcel from any number of networked secondary information sources 120 communicably coupled to the parcel data collection and analysis system 102 via one or more networks 126. Such secondary information sources 120 may include one or more public and/or commercial information sources such as one or more public and/or commercial Websites.

At times, such secondary information sources 120 may provide secondary parcel specific information in the form of textual data associated with the parcel itself or the geographic region in which the parcel is located. Such textual data might include, for example, an independently assessed value of the parcel and any improvements included with the parcel (e.g., structures, commercial structures, and commercial infrastructure).

At times, such secondary information sources 120 may provide secondary parcel specific information in the form of image data associated with the parcel itself or the geographic region in which the parcel is located. In some instances, one or more images of a parcel located at a particular street address or geolocation may be obtained from one or more commercial Websites, such as a Google® Maps “street-view,” Zillow®, Trulia®, or the Multiple Listing Service (“MLS”) Website. In other instances, one or more geotagged images of a parcel located at a particular street address or geolocation may be obtained from crowd source Websites such as Facebook®, Twitter®, Picasa®, Flickr®, Photobucket®, and the like.

At times, such secondary information sources 120 may provide secondary parcel specific information in the form of graphical data associated with the parcel itself or the geographic region in which the parcel is located. In one instance, the parcel data collection and analysis system 102 obtains from one or more commercial Websites, such as Zillow®, Trulia®, or the Multiple Listing Service (“MLS”) Website, one or more graphical images showing property values as a function of time. In another instance, the parcel data collection and analysis system 102 obtains from one or more commercial Websites, such as Zillow®, Trulia®, or the Multiple Listing Service (“MLS”) Website, one or more graphical images showing regional property values and/or property transactions in the form of a “heat map” or similar.

All or a portion of the secondary parcel specific data collected from secondary information sources 120 may be provided as part of the standard functionality of the parcel data collection and analysis system 102. In some implementations, at least a portion of the data collected from at least a portion of the secondary information sources 120 may be provided as a fee-based and/or premium service. An example of such a premium service would include generating at the request of a data consumer an “Ownership and Encumbrance Report” for a particular parcel identified via one or more secondary parcel specific identifiers (e.g., physical or street address) to assist in assessing the condition of the parcel's title.

In some implementations, the parcel data collection and analysis system 102 may store all or a portion of the retrieved primary parcel specific data and the retrieved secondary parcel specific data in a number of indexed or linked data stores or databases retained or otherwise stored in a communicably coupled nontransitory storage media 106. The number of data stores or databases containing the retrieved primary parcel specific data and the retrieved secondary parcel specific data associated with a particular parcel may be indexed or linked using a unique identifier logically associated with the respective parcel. In at least some instances, the parcel identifier associated with the respective parcel provides the unique identifier used to index or link the retrieved primary parcel specific data and the retrieved secondary parcel specific data associated with the respective parcel.

Any number of data consumers 130a-130n (collectively “data consumers 130”) may access some or all of the auction event information and/or parcel specific data via the parcel data collection and analysis system 102 front end 104 such as a Web portal or Website. In some instances, some or all of the data consumers 130 access the parcel data collection and analysis system 102 front end 104 via one or more networks 132. The data consumers 130 may access the parcel data collection and analysis system 102 via any device capable of electronic communication with the parcel data collection and analysis system 102 including, but not limited to, desktop computer 132a, a tablet or other portable electronic device such as a smartphone 132b, or a laptop or ultraportable computer 132n.

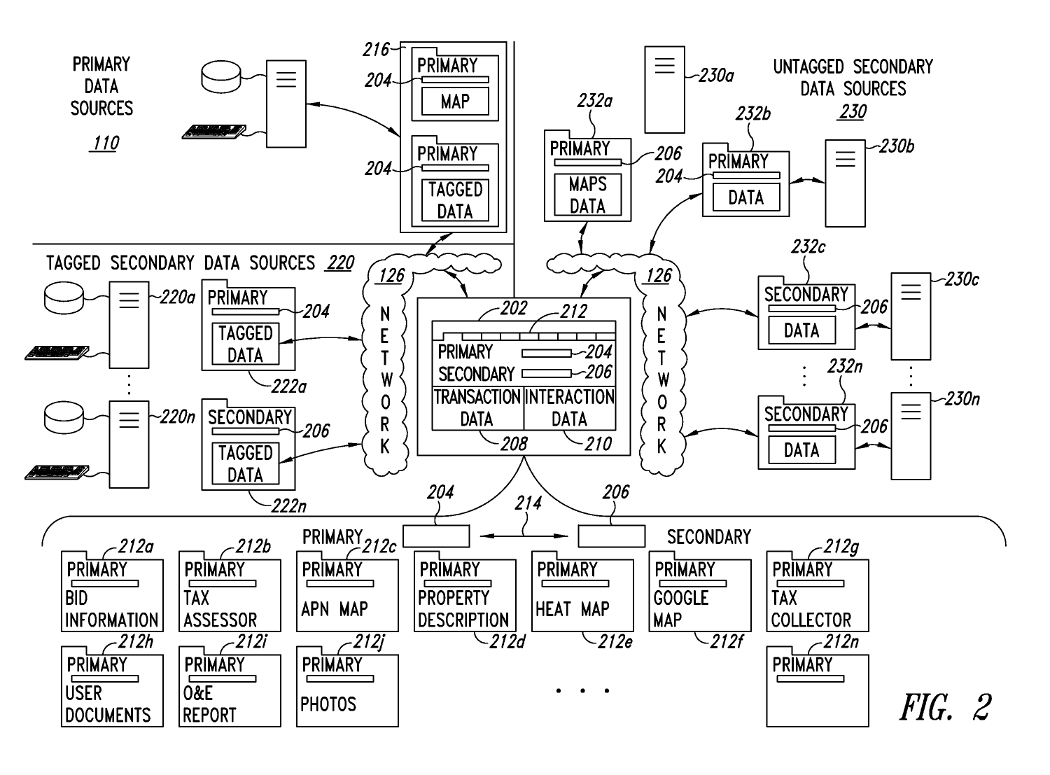

FIG. 2 shows a networked environment 200, in which a tabbed parcel data collection and analysis system user interface 102 provides primary parcel specific information and secondary parcel specific information for a single parcel offered at an auction event in the form of a number of tabbed “pages” or tabs 212a-212n (collectively “tabs 212”), according to one or more embodiments. In at least some instances, the secondary parcel specific information can be apportioned into tagged secondary parcel specific information 222a-222n (collectively, “tagged secondary parcel specific information 222”) supplied by tagged secondary information sources 220a-220n (collectively, “tagged secondary information sources 220”) untagged secondary parcel specific information 232a-232n (collectively, “tagged secondary parcel specific information 232”) supplied by untagged secondary information sources 230a-230n (collectively, “untagged secondary information sources 230”).

Tagged secondary parcel specific information 222 includes any data having a logically associated tag data or similar identification data. For example, data indicative of a value of 150,000 received from a Website where the data is associated with a tag data “ASSESSED” is considered tagged secondary parcel specific information 222. On the other hand, untagged secondary parcel specific information 232 includes any data that is not logically associated with tag data or similar identification data. Using the same example as previous, data indicative of a value of 150,000 received from a Website where the data is not associated with a tag or identifier is considered untagged secondary parcel specific information 232.

Tagged secondary parcel specific information 222 and untagged secondary parcel specific information 232 includes any current or future developed form or format of data including, but not limited to, textual data, image data, bitmap graphic data, vector graphic data, audio data, video data, or combinations thereof. Tagged secondary parcel specific information 222 and untagged secondary parcel specific information 232 may be associated with a primary parcel specific identifier 204, a secondary parcel specific identifier 206, or both. The parcel data collection and analysis system 102 logically associates 214 the primary parcel specific identifier 204 and the secondary parcel specific identifier 206 for each respective parcel. Thus, tagged secondary parcel specific information 222 and untagged secondary parcel specific information 232 associated with a secondary parcel specific identifier 206 is logically associated with the respective primary parcel specific identifier 204 upon receipt by the parcel data collection and analysis system 102.

The parcel data collection and analysis system 102 retrieves primary parcel specific information 216 from one or more primary information sources 110. In some instances, the primary parcel specific information 216 can include one or more forms of data including, but not limited to, textual data, image data, video data, or graphical data. In some instances, the primary parcel specific information may be associated with a particular parcel using the primary parcel specific identifier 204. For example, the parcel data collection and analysis system 102 may access a primary information sources 110 such as a tax assessor/collector Website and access primary parcel specific information 216 using a primary parcel specific identifier 204 such as a parcel ID obtained from a listing of distressed real property parcel auction events. The primary parcel specific information 216 may include textual data such as a written legal description of the property, financial data such as an assessed value of the property, image data such as a digital image of the property taken or otherwise obtained by the tax assessor, and graphical data such as a rendering of the current property tax statement for the parcel. The parcel data collection and analysis system 102 logically associates the primary parcel specific information 216 with the primary parcel specific identifier associated with the respective property. The primary parcel specific information 216 received by the parcel data collection and analysis system 102 may be stored in a nontransitory storage 106 and/or communicated to a data consumer 130.

The parcel data collection and analysis system 102 retrieves tagged secondary parcel specific information 222 from one or more tagged secondary information sources 220. The one or more tagged secondary information sources 220 can include any data source capable of providing tagged secondary parcel specific information 222 to the parcel data collection and analysis system 102. In some instances, the tagged secondary parcel specific information 222a may be associated with a primary parcel specific identifier 204 by the tagged secondary information source 220a. In some instances, the tagged secondary parcel specific information 222n may be associated with a secondary parcel specific identifier 206 by the tagged secondary information source 220n.

In at least some implementations, tagged secondary parcel specific information 222 may be received by the parcel data collection and analysis system 102 from one or more Websites, for example MLS.com. MLS.com presents multiple-listing service data in a tagged format. Such information often includes parcel information and information related to improvements to the parcel such as single or multi-family residences, commercial structures, and infrastructure.

The parcel data collection and analysis system 102 retrieves untagged secondary parcel specific information 232 from one or more untagged secondary information sources 230. The one or more untagged secondary information sources 230 can include any data source capable of providing untagged secondary parcel specific information 232 to the parcel data collection and analysis system 102. In some instances, the untagged secondary parcel specific information 232a may be associated with a secondary parcel specific identifier 206 by the untagged secondary information source 230a. In other instances, the untagged secondary parcel specific information 232b may be associated with the primary parcel specific identifier 204 by the untagged secondary information source 230b.

The parcel data collection and analysis system 102 forms a logical association 214 between a primary parcel specific identifier 204 and one or more secondary parcel specific identifiers 206. In at least some implementations, the parcel data collection and analysis system 102 can form a logical association 214 between a primary parcel specific identifier 204 such as a parcel ID and a secondary parcel specific identifier 206 such as a parcel physical address. In other implementations, the parcel data collection and analysis system 102 can form a logical association 214 between a primary parcel specific identifier 204 such as a parcel ID and a secondary parcel specific identifier 206 such as a parcel geolocation (e.g., longitude/latitude coordinates). Thus, all of the primary parcel specific information 216, tagged secondary parcel specific information 222, and untagged secondary parcel specific information 232 received by the parcel data collection and analysis system 102 is logically associated by the parcel data collection and analysis system 102 with the primary parcel specific identifier 204 of the respective parcel. The parcel data collection and analysis system 102 thus advantageously and beneficially links or otherwise logically associates with a single identifier all of the primary parcel specific information 216, tagged secondary parcel specific information 222, and untagged secondary parcel specific information 232 gathered from any number of primary information sources 110 and secondary information sources 120.

By linking all of the primary parcel specific information 216, tagged secondary parcel specific information 222, and untagged secondary parcel specific information 232, the parcel data collection and analysis system 102 is able to provide the data consumer 130 with an otherwise unavailable, comprehensive, set of data organized by parcel. Even more beneficially, by linking all of the primary parcel specific information 216, tagged secondary parcel specific information 222, and untagged secondary parcel specific information 232, the parcel data collection and analysis system 102 is able to analyze data received from a number of different sources of information thereby advantageously providing comprehensive analytical capabilities using data autonomously retrieved from a number of sources.

For example, data obtained from a primary information source 110 (e.g., tax assessor/collector office) may indicate a distressed parcel (primary parcel specific identifier 204=Parcel ID: 323C-23001000) appraised at $200,000 is available for a bidding starting at $20,000 (i.e., 10% of appraised value). The parcel data collection and analysis system 102 logically associates the primary parcel specific identifier 204 (Parcel ID: 323C-23001000) with a secondary parcel specific identifier 206 (Address: 123 Main Street, Kearney, Nebr.). While the ratio of bid to assessed value is attractive at 10%, data obtained from a first secondary information source 120a (e.g., Homes.com) may indicate prior sales in the neighborhood of 123 Main Street, Kearney, Nebr. have all been distressed properties at values of $10,000 to $15,000. Data obtained from a second secondary information source 120b (e.g., Trulia.com) may indicate via a heat map graphic that properties neighboring 123 Main Street, Kearney, Nebr. are remaining on the market between 18 and 24 months. Finally, data obtained from a third secondary information source 120c (e.g., Zillow.com) may indicate an estimated value for 123 Main Street, Kearney, Nebr. of $12,500. The parcel data collection and analysis system 102 beneficially provides this information to a data consumer 130 in a comprehensive format that assists the data consumer 130 in performing the necessary due diligence prior to making a purchasing decision on the distressed real property at 123 Main Street, Kearney, Nebr.

In some instances, the parcel data collection and analysis system 102 can provide the received primary parcel specific information 216 and the received secondary parcel specific information for any number of parcels in a tabular format (i.e., a spreadsheet—not shown in FIG. 2) that beneficially facilitates a “side-by-side” comparison of data for the number of parcels. Such a tabular format may feature user definable, selectable, or reconfigurable data column. In at least some instances, the tabular format presentation may include one or more data consumer definable searches or filters to selectively limit or otherwise selectively restrict the parcel data included in the tabular format presentation to those parcels meeting one or more defined criteria.

In other instances, such as that depicted in FIG. 2, the parcel data collection and analysis system 102 provides the received primary parcel specific information 216 and the received secondary parcel specific information to the data consumer 130 in a variety of formats. In some instances, the parcel data collection and analysis system 102 provides the received primary parcel specific information 216 and the received secondary parcel specific information as a series of pages or sheets presented in a tabbed format. In the tabbed format, a number of tabs 212a-212n (collectively “tabs 212”) or similar devices provide the data consumer 130 with access to various pages, each page containing data, graphics, analytics, or combinations thereof that are associated with a single parcel and are indexed, linked, or logically related by the parcel data collection and analysis system 102 via the primary parcel specific identifier 204 associated with the respective parcel. In at least some instances, the tabbed format presentation 202 may include one or more data consumer definable searches or filters to selectively limit or otherwise selectively restrict the data to a number of parcels meeting one or more defined criteria.

Each of the pages associated with a particular tab are indexed, linked, or logically related by the parcel data collection and analysis system 102 via the primary parcel specific identifier 204 associated with the respective parcel. Thus, in some implementations, the primary parcel specific identifier 204 appears on each tab 212a-212n. Examples of the data displayed by various tabs present in an example tabbed format presentation 202 are provided below with the understanding that the content of any individual tab 212 can change, be increased, or reduced based on the number of primary information sources 110 and secondary information sources 120 accessed. Such reduced or enhanced data content falls within the scope of this disclosure. Additional tabs may be added to accommodate additional primary parcel specific information 216, tagged secondary parcel specific information 222, and untagged secondary parcel specific information 232.

The Bid Information tab 212a can include data collected from one or more primary information sources 110 and/or one or more secondary information sources 120 related to the parcel and the auction requirements associated with the parcel. Data presented in the Bid Information tab 212a may include information obtained from a primary information source 110 and/or secondary information source 120. Such data may include, but is not limited to, a minimum bid amount, an assessed value of the property, a legal description of the property, an address of the property (where available), data indicative of whether the property is improved or unimproved, data indicative of any improvements present on the property, neighboring property values, independently assessed property values, and the like.

In at least some instances, the parcel data collection and analysis system 102 provides analytical data on the Bid Information tab 212a. In one instance, the parcel data collection and analysis system 102 may determine the starting bid value as a percentage of jurisdictional tax assessor's assessed value (e.g., $20,000 starting bid on $200,000 assessed value=10%). In another instance, the parcel data collection and analysis system 102 may determine the starting bid value as a percentage of third party's assessed value (e.g., $20,000 starting bid on $300,000 assessed value as determined by Zillow.com=6.7%). In yet another instance, the data consumer 130 may search for parcels based on analytical data determined by the parcel data collection and analysis system 102 (e.g., display parcels where starting bid value as a percentage of third-party assessed value is less than starting bid value as a percentage of jurisdictional tax assessor's assessed value).

The Tax Assessor tab 212b includes data collected from one or more primary information sources 110 and/or one or more secondary information sources 120 associated with the parcel provided by the jurisdictional tax assessor's office. The Tax Assessor tab 212b is logically associated with the other tabs 212 by the primary parcel specific identifier 204 (e.g., the tax assessor assigned Parcel ID). Information appearing on the Tax Assessor tab 212b tab may include parcel location information, identification of any improvements present on the parcel, structure details of any structural improvements on the parcel, assessed value land and any improvements, an assessment history, and the like. The Tax Assessor tab 212b may also optionally include graphical or image data such as tax maps, parcel maps, photographs of the parcel and any improvements, and similar.

The Assessor's Parcel Number (“APN”) Map tab 212c includes graphical data collected from one or more primary information sources 110 and/or one or more secondary information sources 120 such as an assessor's parcel map provided by the local jurisdictional tax assessor's office. The APN Map tab 212c is logically associated with the other tabs 212 by the primary parcel specific identifier 204 (e.g., the tax assessor assigned Parcel ID).

The Property Description tab 212d includes data collected from one or more primary information sources 110 and/or one or more secondary information sources 120. The data or information included on the Property Description tab 212d relates to parcel details and specific auction requirements associated with the sale of the parcel. The Property Description tab 212d is logically associated with the other tabs 212 using the primary parcel specific identifier 204 (e.g., Parcel ID). Information on the Property Description tab 212d may include information obtained from the jurisdictional tax assessor/collector's office (e.g., parcel square footage, structure square footage, structure details, and the like). Information included on the Property Description tab 212d may include information obtained from one or more private or commercial sources such as one or more Websites. Such information may be obtained, for example, from one or more real estate websites such as Zillow.com, Trulia.com, Homes.com, and/or Realtor.com. Such information may include parcel details unavailable via other sources, for example prior sale information associated with the property may be included.

The Heat Map tab 212e includes data collected from one or more primary information sources 110 and/or one or more secondary information sources 120. In at least some instances, the Heat Map tab 212e includes data related to the geographic region in which the parcel is located. The Heat Map tab 212e is logically associated with the other tabs 212 using the primary parcel specific identifier 204 (e.g., Parcel ID). Information on the Heat Map tab 212e may include graphical data indicative of real estate values, real estate transactions, closed real estate transactions, pending real estate transactions, or any other data indicative of real estate values or real estate transactions conducted in the geographic region surrounding the parcel. Advantageously and beneficially, the data consumer 130 does not exit the parcel data collection and analysis system 102 to view a heat map obtained from one or more external Websites.

The Google Map tab 212f includes data collected from one or more secondary information sources 120. The Google Map tab 212f includes cartographic data related to the physical location in which the parcel is located. The Google map tab 212F is logically associated with the other tabs 212 using the primary parcel specific identifier 204 (e.g., Parcel ID) which is determined by the parcel data collection and analysis system 102 based on the secondary parcel specific identifier (e.g., physical address, geolocation coordinates) used to identify the parcel in Google maps. In at least some instances, the Google Maps tab 212f may include additional views of the parcel obtained, for example, using Google's “Street View” technology. Advantageously and beneficially, the data consumer 130 does not exit the parcel data collection and analysis system 102 to view the Google map or Google Street view images.

The Tax Collector tab 212g includes data collected from one or more primary information sources 110 and/or one or more secondary information sources 120. The Tax Collector tab 212g includes data related to current and prior jurisdictional tax obligations of the parcel owner prior. The Tax Collector tab 212g is logically associated with the other tabs 212 using the primary parcel specific identifier 204 (e.g., Parcel ID). In at least some instances, the parcel data collection and analysis system 102 provides images of current and former tax bills as linked PDF files or as documents visible in a PDF viewer included in the Tax Collector tab 212g. Advantageously and beneficially, the data consumer 130 does not exit the parcel data collection and analysis system 102 to view data obtained from the jurisdictional tax collector's Website.

The User Documents tab 212h provides the data consumer 130 with a location to enter notes or links to other system or external documents associated with the property. Importantly, the information, links, or other data provided by the data consumer 130 on the User Documents tab is logically associated with the primary parcel specific identifier 204 by the parcel data collection and analysis system 102.

The Ownership and Encumbrance (“O&E”) Report tab 212i provides the data consumer 130 with an O&E report document prepared (generally for an additional fee) by an external agency. Such O&E Reports provide the data consumer 130 with information on at least a portion of the title history for the parcel. In at least some instances, the parcel data collection and analysis system 102 provides images of the externally prepared O&E report for the parcel as linked PDF files or as documents visible in a PDF viewer included in the O&E Report tab 212i. Advantageously and beneficially, the data consumer 130 does not exit the parcel data collection and analysis system 102 to view data obtained from an external O&E report preparation service.

The Photos Tab 212j provides the data consumer 130 with image, video, audio, and/or audiovisual data associated with a secondary parcel specific identifier 206 associated with the property. Such information may include data obtained from one or more crowd source Websites such as Facebook, Twitter, Picasa, Flickr, Photobucket, or the like. In at least some instances, the parcel data collection and analysis system 102 autonomously retrieves online image, video, audio, and/or audiovisual data logically associated with a physical address or a geotag corresponding to or within a defined range (e.g., 0.10 miles, 0.25 miles, 0.50 miles) of a secondary parcel specific identifier associated with the parcel for inclusion as embedded or linked objects on the Photos Tab 212j. Advantageously and beneficially, the data consumer 130 does not exit the parcel data collection and analysis system 102 to view data autonomously retrieved by the parcel data collection and analysis system 102 from one or more secondary sources.

Although the above tabs provide illustrative examples, additional tabs including data retrieved from any number of primary sources 204 and/or secondary sources 206 may be provided. Additionally, the parcel data collection and analysis system 102 can analyze, track, trend or otherwise combine data retrieved from the primary and secondary sources to provide additional data suitable for inclusion on one or more new or existing tabs.

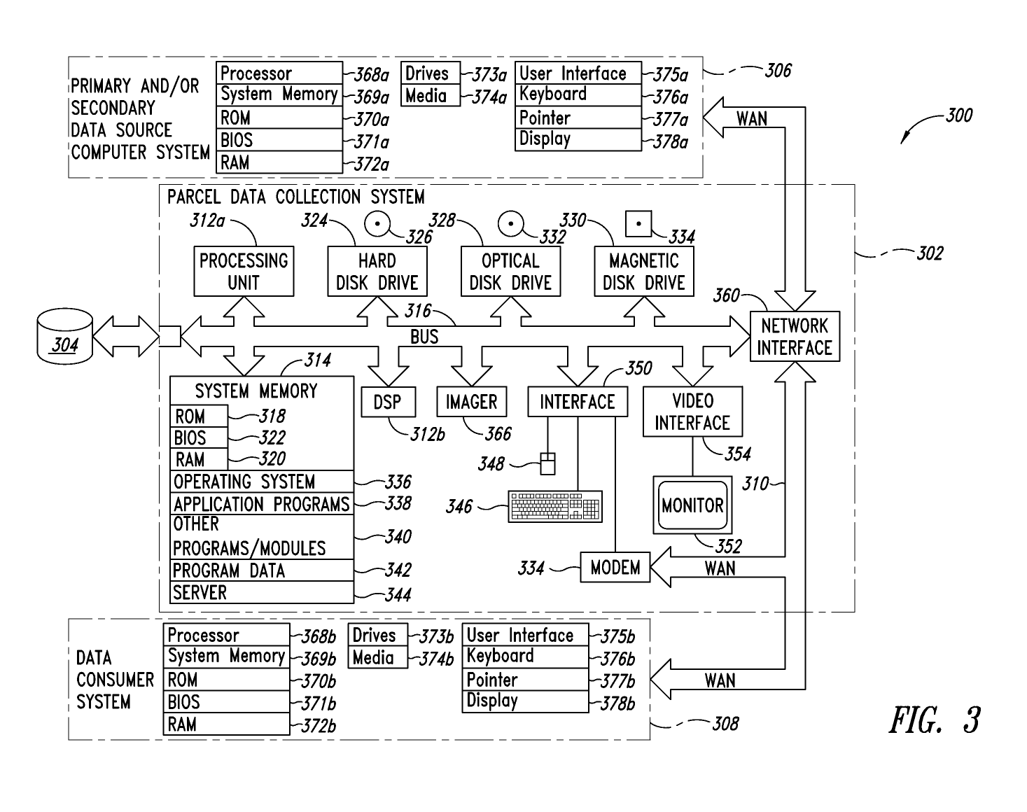

FIG. 3 and the following discussion provide a brief, general description of a suitable networked parcel data collection and analysis system environment 300 in which the various illustrated embodiments can be implemented. Although not required, the embodiments will be described in the general context of computer-executable instructions, such as program application modules, objects, or macros stored on computer- or processor-readable media and executed by a computer or processor. Those skilled in the relevant art will appreciate that the illustrated embodiments, as well as other embodiments, can be practiced with other system configurations and/or other computing system configurations, including hand-held devices, multiprocessor systems, microprocessor-based or programmable consumer electronics, personal computers (“PCs”), networked PCs, mini computers, mainframe computers, and the like. The embodiments can be practiced in distributed computing environments where tasks or modules are performed by remote processing devices, which are linked through a communications network. In a distributed computing environment, program modules may be located in both local and remote memory storage devices or media.

FIG. 3 shows a networked parcel data collection and analysis system environment 300 comprising one or more parcel data collection and analysis system server computer systems 302 (only one illustrated) and one or more associated nontransitory computer- or processor readable storage medium 304 (only one illustrated). The associated nontransitory computer- or processor readable storage medium 304 is communicatively coupled to the parcel data collection and analysis system(s) 302 via one or more communications channels, for example one or more parallel cables, serial cables, or wireless channels capable of high speed communications, for instance via Universal Serial Bus (USB) 3.0, Firewire®, or similar.

The networked parcel data collection and analysis system environment 300 also comprises one or more primary and/or secondary data source computer systems 306 (only one illustrated) and one or more data consumer computer systems 308 (only one illustrated). The one or more primary and/or secondary data source computer systems 306 and the one or more data consumer computer systems 308 are communicatively coupled to the parcel data collection and analysis system(s) 302 by one or more communications channels, for example one or more wide area networks (WANs) 310, for instance the Internet using Internet protocols. In operation, the one or more primary and/or secondary data source computer systems 306 typically function as either a server to other computer systems associated with a respective primary information source 110 and/or secondary information source 120 or function as end user computer systems themselves. In operation, the parcel data collection and analysis system(s) 302 typically functions as a server with respect to the one or more primary and/or secondary data source computer systems 306 and/or the one or more data consumer computer systems 308.

The networked parcel data collection and analysis system environment 300 may employ other computer systems and network equipment, for example additional servers, proxy servers, firewalls, routers and/or bridges. The parcel data collection and analysis system(s) 302 will at times be referred to in the singular herein, but this is not intended to limit the embodiments to a single device since in typical embodiments there may be more than one parcel data collection and analysis system(s) 302 involved. Unless described otherwise, the construction and operation of the various blocks shown in FIG. 3 are of conventional design. As a result, such blocks need not be described in further detail herein, as they will be understood by those skilled in the relevant art.

The parcel data collection and analysis system(s) 302 may include one or more processing units 312a, 312b (collectively 312), a system memory 314 and a system bus 316 that couples various system components including the system memory 314 to the processing units 312. The processing units 312 may be any logic processing unit, such as one or more central processing units (CPUs) 312a, digital signal processors (DSPs) 312b, application-specific integrated circuits (ASICs), field programmable gate arrays (FPGAs), etc. The system bus 316 can employ any known bus structures or architectures, including a memory bus with memory controller, a peripheral bus, and/or a local bus. The system memory 314 includes read-only memory (“ROM”) 318 and random access memory (“RAM”) 320. A basic input/output system (“BIOS”) 322, which can form part of the ROM 318, contains basic routines that help transfer information between elements within the parcel data collection and analysis system(s) 302, such as during start-up.

The parcel data collection and analysis system(s) 302 may include a hard disk drive 324 for reading from and writing to a hard disk 326, an optical disk drive 328 for reading from and writing to removable optical disks 332, and/or a magnetic disk drive 330 for reading from and writing to magnetic disks 334. The optical disk 332 can be a CD-ROM, while the magnetic disk 334 can be a magnetic floppy disk or diskette. The hard disk drive 324, optical disk drive 328 and magnetic disk drive 330 may communicate with the processing unit 312 via the system bus 316. The hard disk drive 324, optical disk drive 328 and magnetic disk drive 330 may include interfaces or controllers (not shown) coupled between such drives and the system bus 316, as is known by those skilled in the relevant art. The drives 324, 328 and 330, and their associated computer-readable media 326, 332, 334, provide nonvolatile storage of computer-readable instructions, data structures, program modules and other data for the master node server computer system 202. Although the depicted parcel data collection and analysis system(s) 302 is illustrated employing a hard disk 324, optical disk 328 and magnetic disk 330, those skilled in the relevant art will appreciate that other types of computer-readable media that can store data accessible by a computer may be employed, such as WORM drives, RAID drives, magnetic cassettes, flash memory cards, digital video disks (“DVD”), Bernoulli cartridges, RAMs, ROMs, smart cards, etc.

Program modules can be stored in the system memory 314, such as an operating system 336, one or more application programs 338, other programs or modules 340 and program data 342. Application programs 338 may include instructions that cause the processor(s) 312 to automatically store to the associated nontransitory computer- or processor readable storage medium 304 parcel data retrieved from one or more primary information sources 110 and one or more secondary information sources 120 in a number of data stores and/or databases that are dynamically linked by a unique primary parcel specific identifier 204 associated with each respective parcel. Application programs 338 may include instructions that cause the processor(s) 312 to automatically control access to certain information based on certain criteria. For example, a data consumer 130 may be provided access to parcel data for only a limited subscription area (e.g., city, county, state) or a data consumer 130 may receive information commensurate with and defined as included in one or more subscription plans or tiers. Application programs 338 may include instructions that cause the processor(s) 312 to create “robots,” “spiders,” “bots” or other similar automated data acquisition devices that autonomously retrieve primary parcel specific identifiers associated with properties offered for sale at an auction event. Application programs 338 may include instructions that cause the processor(s) 312 to create “robots,” “spiders” or other similar automated data acquisition devices that retrieve data from one or more primary information sources 110 using a primary parcel specific identifier 204 (e.g., parcel ID). Application programs 338 may include instructions that cause the processor(s) 312 to create “robots,” “spiders” or other similar automated data acquisition devices that retrieve data from one or more secondary information sources 120 using one or more secondary parcel specific identifiers 204 (e.g., physical address, geolocation coordinates).

Other program modules 340 may include instructions for handling security such as password or other access protection and communications encryption. The system memory 314 may also include communications programs, for example a server 344 that causes the parcel data collection and analysis system(s) 302 to serve electronic or digital documents or files via corporate intranets, extranets, or other networks as described below. The server 344 in the depicted embodiment is markup language based, such as Hypertext Markup Language (HTML), Extensible Markup Language (XML) or Wireless Markup Language (WML), and operates with markup languages that use syntactically delimited characters added to the data of a document to represent the structure of the document. A number of suitable severs may be commercially available such as those from Mozilla, Google, Microsoft and Apple Computer.

While shown in FIG. 3 as being stored in the system memory 314, the operating system 336, application programs 338, other programs/modules 340, program data 342 and browser 344 can be stored on the hard disk 326 of the hard disk drive 324, the optical disk 332 of the optical disk drive 328 and/or the magnetic disk 334 of the magnetic disk drive 330.

An operator can enter commands and information into the parcel data collection and analysis system(s) 302 through input devices such as a touch screen or keyboard 346 and/or a pointing device such as a mouse 348, and/or via a graphical user interface. Other input devices can include a microphone, joystick, game pad, tablet, scanner, etc. These and other input devices are connected to one or more of the processing units 312 through an interface 350 such as a serial port interface that couples to the system bus 316, although other interfaces such as a parallel port, a game port or a wireless interface or a universal serial bus (“USB”) can be used. A monitor 352 or other display device is coupled to the system bus 316 via a video interface 354, such as a video adapter. The parcel data collection and analysis system(s) 302 can include other output devices, such as speakers, printers, etc.

The parcel data collection and analysis system(s) 302 can operate in a networked environment using logical connections to one or more remote computers and/or devices. For example, the parcel data collection and analysis system(s) 302 can operate in a networked environment using logical connections to one or more one or more primary and/or secondary data source computer systems 306 and the one or more data consumer computer systems 308. Communications may be via tethered (i.e., wired) and/or wireless network architecture, for instance wired and wireless enterprise-wide computer networks, intranets, extranets, and/or the Internet. Other embodiments may include other types of communications networks including telecommunications networks, cellular networks, paging networks, and other mobile networks. There may be any variety of computers, switching devices, routers, bridges, firewalls and other devices in the communications paths between the parcel data collection and analysis system(s) 302 and the one or more primary and/or secondary data source computer systems 306 and the one or more data consumer computer systems 308.

The one or more primary and/or secondary data source computer systems 306 will typically take the form of one or more servers or similar data delivery devices operated by either a primary information source 110 or a secondary information source 120. In at least some instances, the parcel data collection and analysis system(s) 302 can autonomously provide one or more primary parcel specific identifiers 204 (e.g., parcel IDs) or one or more secondary parcel specific identifiers 206 (e.g., physical addresses or geolocations) to access parcel specific data on the one or more primary and/or secondary data source computer systems 306, respectively.

The one or more data consumer computer systems 308 will typically take the form of end user processor-based devices, for instance personal computers (e.g., desktop or laptop computers), netbook computers, tablet computers and/or smartphones and the like, executing appropriate instructions. These end user processor-based devices may be communicatively coupled to one or more server computers. The one or more data consumer computer systems 308 may execute a set of client instructions to function as a client of the server computer(s), which are communicatively coupled via a WAN.

The one or more primary and/or secondary data source computer systems 306 and the one or more data consumer computer systems 308 may include one or more processing units 368a, 368b (collectively 368), system memories 369a, 369b (collectively 369) and a system bus (not shown) that couples various system components including the system memory 369 to the processing unit 368. The one or more primary and/or secondary data source computer systems 306 and the one or more data consumer computer systems 308 will at times each be referred to in the singular herein, but this is not intended to limit the embodiments to a single primary and/or secondary data source computer systems 306 and/or the one or more data consumer computer systems 308. In typical embodiments, there may be more than one primary and/or secondary data source computer systems 306 and there will likely be a large number of one or more data consumer computer systems 308.

The processing unit 368 may be any logic processing unit, such as one or more central processing units (CPUs), digital signal processors (DSPs), application-specific integrated circuits (ASICs), field programmable gate arrays (FPGAs), etc. Non-limiting examples of commercially available computer systems include, but are not limited to, an 80×86 or Pentium series microprocessor from Intel Corporation, U.S.A., a PowerPC microprocessor from IBM, a Sparc microprocessor from Sun Microsystems, Inc., a PA-RISC series microprocessor from Hewlett-Packard Company, or a 68xxx series microprocessor from Motorola Corporation. Unless described otherwise, the construction and operation of the various blocks of the primary and/or secondary data source computer systems 306 shown in FIG. 3 are of conventional design. As a result, such blocks need not be described in further detail herein, as they will be understood by those skilled in the relevant art.

The system bus can employ any known bus structures or architectures, including a memory bus with memory controller, a peripheral bus, and a local bus. The system memory 369 includes read-only memory (“ROM”) 370a, 370b (collectively 370) and random access memory (“RAM”) 372a, 372b (collectively 372). A basic input/output system (“BIOS”) 371a, 371b (collectively 371), which can form part of the ROM 370, contains basic routines that help transfer information between elements within the one or more primary and/or secondary data source computer systems 306 and the one or more data consumer computer systems 308, such as during start-up.

The one or more primary and/or secondary data source computer systems 306 and the one or more data consumer computer systems 308 may also include one or more media drives 373a, 373b (collectively 373), e.g., a hard disk drive, magnetic disk drive, WORM drive, and/or optical disk drive, for reading from and writing to computer-readable storage media 374a, 374b (collectively 374), e.g., hard disk, optical disks, and/or magnetic disks. The computer-readable storage media 374 may, for example, take the form of removable media. For example, hard disks may take the form of a Winchester drives, and optical disks can take the form of CD-ROMs, while magnetic disks can take the form of magnetic floppy disks or diskettes. The media drive(s) 373 communicate with the processing unit 368 via one or more system buses. The media drives 373 may include interfaces or controllers (not shown) coupled between such drives and the system bus, as is known by those skilled in the relevant art. The media drives 373, and their associated computer-readable storage media 374, provide nonvolatile storage of computer readable instructions, data structures, program modules and other data for the one or more primary and/or secondary data source computer systems 306 and/or the one or more data consumer computer systems 308. Although described as employing computer-readable storage media 374 such as hard disks, optical disks and magnetic disks, those skilled in the relevant art will appreciate that the one or more primary and/or secondary data source computer systems 306 and the one or more data consumer computer systems 308 may employ other types of computer-readable storage media that can store data accessible by a computer, such as magnetic cassettes, flash memory cards, digital video disks (“DVD”), Bernoulli cartridges, RAMs, ROMs, smart cards, etc. Data or information, for example, electronic or digital documents or files or data (e.g., metadata, ownership, authorizations) related to such can be stored in the computer-readable storage media 374.

Program modules, such as an operating system, one or more application programs, other programs or modules and program data, can be stored in the system memory 369. Program modules stored in the system memory 369a of the one or more primary and/or secondary data source computer systems 306 can include one or more Web server applications such as Apache Web Server. Program modules stored in the system memory 369b of the one or more data consumer computer systems 308 may include instructions for accessing a Website, extranet site or other site or services (e.g., Web services) and associated WebPages, other pages, screens or services. Program modules on either or both the one or more primary and/or secondary data source computer systems 306 and the one or more data consumer computer systems 308 may additionally include instructions for handling security such as ownership, password or other access protection and communications encryption.

While described as being stored in the system memory 369, the operating system, application programs, other programs/modules, program data and/or browser can be stored on the computer-readable storage media 374 of the media drive(s) 373. An operator can enter commands and information into the one or more primary and/or secondary data source computer systems 306 and the one or more data consumer computer systems 308 via a user interface 375a, 375b (collectively 375) through input devices such as a touch screen or keyboard 376a, 376b (collectively 376) and/or a pointing device 377a, 377b (collectively 377) such as a mouse. Other input devices can include a microphone, joystick, game pad, tablet, scanner, etc. These and other input devices are connected to the processing unit 369 through an interface such as a serial port interface that couples to the system bus, although other interfaces such as a parallel port, a game port or a wireless interface or a universal serial bus (“USB”) can be used. A display or monitor 378a, 378b (collectively 378) may be coupled to the system bus via a video interface, such as a video adapter. The one or more primary and/or secondary data source computer systems 306 and the one or more data consumer computer systems 308 can include other output devices that are not shown in FIG. 3, such as speakers, printers, etc.

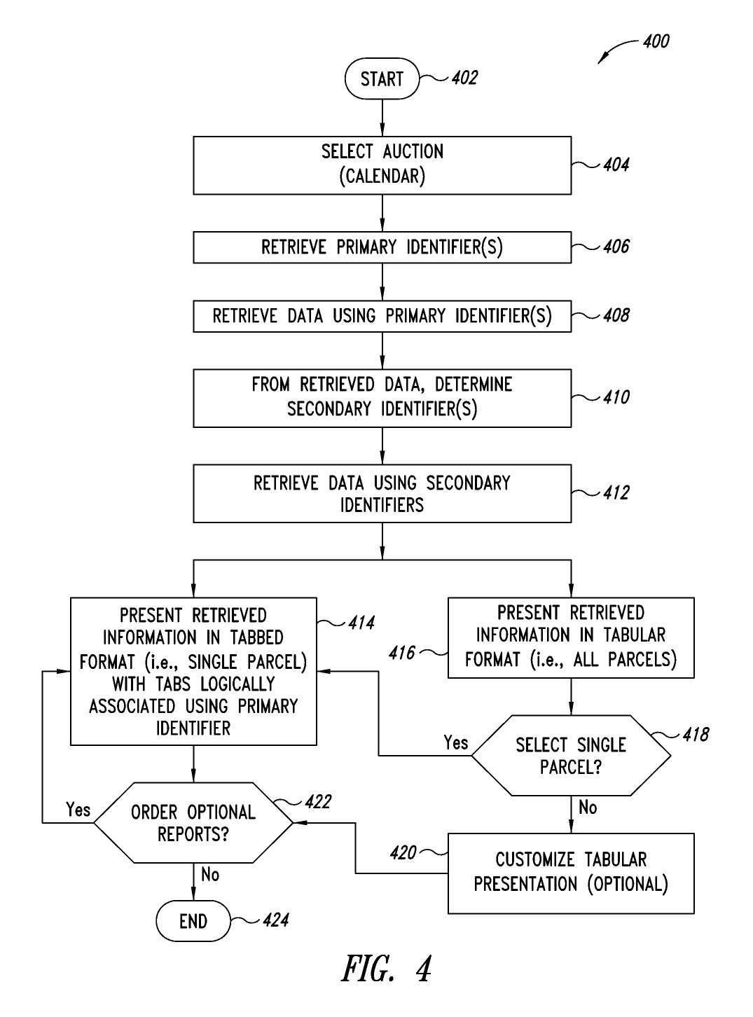

FIG. 4 shows an illustrative method 400 of collecting and analyzing information associated with one or more distressed real property parcels offered for sale at a real property auction event, according to one embodiment. Tax jurisdictions and municipalities have various processes and procedures for obtaining outstanding amounts owed for taxes and/or utilities from parcel owners. Ultimately, if the parcel owner fails to pay the amounts owed for taxes and/or utilities, the real property parcel is considered a “distressed real property parcel” which is offered for purchase at an auction event. Any number of such properties may be offered at such auction events.

For investors, these distressed real property parcels represent an opportunity since many are sold at less than market value. However, tracking the auctions, identifying the parcels, and collecting the information needed to perform a thorough due-diligence effort prior to purchase has heretofore required a significant time investment scouring a multitude of locations to access and analyze the needed information. The method 400 of collecting and analyzing information associated with one or more distressed real property parcels offered for sale at a real property auction event advantageously provides investors with a rapid, accurate, and comprehensive collection of information and analyses to thoroughly evaluate each of the sometimes large number parcels offered at such auctions.

Briefly, the method 400 commences with the selection by a data consumer 130 (e.g., an investor) of a scheduled distressed real property auction event for analysis. Each of the parcels offered at the auction event are identified using a primary parcel specific identifier 204 that typically, although not always, is the taxing authority's parcel identifier or “parcel ID.” Using the primary parcel specific identifier 204, the parcel data collection and analysis system 102 creates a robot or “bot” to autonomously “scrape” or retrieve data associated with the primary parcel specific identifier 204 from a number of primary information sources 110 and/or a number of secondary data sources 206. The parcel data collection and analysis system 102 also attempts to match a secondary parcel specific identifier 206 such as an address or geolocations (e.g., longitude/latitude) with the primary parcel specific identifier 204. The parcel data collection and analysis system 102 logically associates the primary parcel specific identifier 204 with one or more secondary parcel specific identifiers 206.

Using the secondary parcel specific identifier 206, the parcel data collection and analysis system 102 creates a robot or “bot” to autonomously “scrape” or retrieve additional data associated with the secondary parcel specific identifier 206 from a number of primary information sources 110 and/or a number of secondary data sources 206. The scraped data obtained using the primary parcel specific identifier 204 and one or more secondary parcel specific identifiers 206 can include textual data, image data, graphical data, or any other data. The parcel data collection and analysis system 102 analyzes and filters the data at the direction of the data consumer 130 and presents the data to the data consumer in either a tabbed format (by individual parcel) or a tabular (i.e., spreadsheet) format (that includes a number of parcels). Additionally, the data consumer may also have access to other reports, analyses, or data (e.g., Ownership and Encumbrance reports, Title Searches, and the like) on a “for-fee” basis. The method 400 of collecting and analyzing information associated with one or more distressed real property parcels offered for sale at a real property auction event commences at 402.

At 404, the data consumer selects a real property auction event for data collection and analysis. In at least some implementations, the data consumer 130 indicates a real property auction event via a selectable icon graphically displayed on a calendar-style user interface.

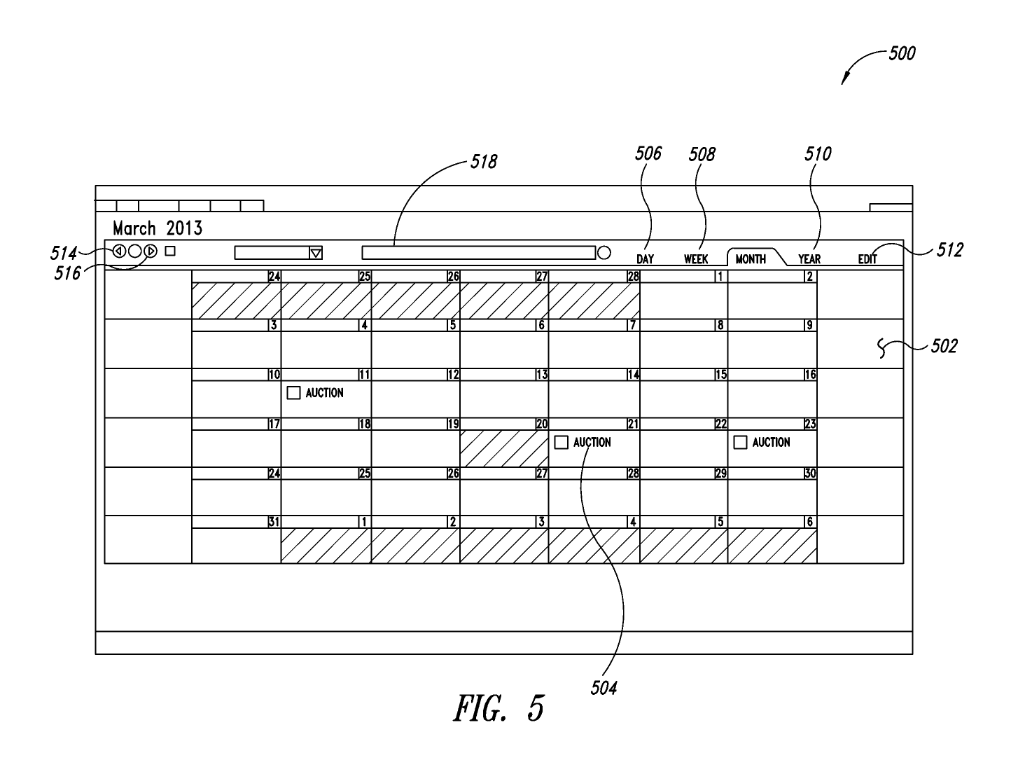

FIG. 5 shows a screen capture of an illustrative calendar-style user interface 500. The illustrative calendar-style user interface 500 presents a number of selectable auction icons 504 positioned on a calendar background or graphic 502. The calendar-style user interface 500 can include different views, for example a “DAY” view 506 showing real property auction events scheduled for a particular day; a “WEEK” view 508 showing real property auction events scheduled for a particular week; or a “YEAR” view 510 showing real property auction events scheduled for an entire year. The calendar-style user interface 500 can also include an “EDIT” mode 512 in which the data consumer 130 can edit the displayed auction event icons 504 (e.g., edit the text associated with a particular icon, for example to indicate an extremely attractive auction event). The calendar-style user interface 500 can include a FORWARD navigation and BACK navigation icons 514, 516 (respectively) to navigate forward and backwards on a day-by-day, week-by-week, month-by-month, or year-by-year basis. The calendar-style user interface 500 can also include a text search box 518 that provides the data consumer with the ability to search for particular terms (e.g., a search for “Cuyahoga” might return all of the auction events scheduled for Cuyahoga County, Ohio).

Returning now to FIG. 4, at 406, for each selected real property auction event, the parcel data collection and analysis system 102 retrieves the primary parcel specific identifiers 204 associated with some or all of the parcels offered for sale. In at least some instances, the retrieved primary parcel specific identifiers 204 can include an identifier assigned by a local or regional taxation authority. Such primary parcel specific identifiers are commonly referred to as “Parcel IDs.”

At 408, for each of the retrieved primary parcel specific identifiers 204, the parcel data collection and analysis system 102 retrieves primary parcel specific information 216 from a number of primary information sources 110. In at least some instances, the primary information sources 110 may include the auction Website itself.

At 410, using the parcel specific information retrieved at 408, the parcel data collection and analysis system 102 attempts to determine at least one secondary parcel specific identifier 206 associated with each of the primary parcel specific identifiers 204 retrieved at 406. Secondary parcel specific identifiers may include any information or data suitable for physically locating the respective parcel. Such secondary parcel specific identifiers typically include, but are not limited to, a physical street address for the respective parcel and/or geolocations (e.g., longitude and latitude) for the respective parcel. The identification of at least one secondary parcel specific identifier 206 permits the parcel data collection and analysis system 102 to perform an additional information search for the respective property using the secondary parcel specific identifier 206. Where the parcel data collection and analysis system 102 locates a secondary parcel specific identifier 206, the parcel data collection and analysis system 102 logically associates the secondary parcel specific identifier 206 with the primary parcel specific identifier 204 associated with the respective parcel.

At 412, for each of the primary parcel specific identifiers 204, and for each of the secondary parcel specific identifiers 206, the parcel data collection and analysis system 102 retrieves tagged secondary parcel specific information 222 from a number of tagged secondary information sources 220 and untagged secondary parcel specific information 232 from a number of untagged secondary information sources 230. In at least some instances, the secondary information sources 120 may include other Websites having parcel information accessible using the primary parcel specific identifier.

Tagged secondary parcel specific information 222 includes any information having an associated tag or descriptor permitting the parcel data collection and analysis system 102 to identify the nature of the retrieved data. Such tagged data may be retrieved from Websites such as a tax assessor Website, and/or tax collector Website.

Untagged secondary parcel specific information 232 includes any data or information without an associated tag or descriptor. Such untagged data may be retrieved from Website such as Zillow.com, Homes.com, Trulia.com, Remax.com, MLS.com, and the like.

Since the parcel data collection and analysis system 102 logically associated the secondary parcel specific identifiers 206 with a primary parcel specific identifier 204 at 410, all or a portion of the retrieved tagged secondary parcel specific information 222 and untagged secondary parcel specific information 232 is logically associated with the primary parcel specific identifier 204 for the respective parcel. Thus, the primary parcel specific identifier 204 provides a link between all of the retrieved primary data 216, the retrieved tagged secondary parcel specific information 222 and the retrieved untagged secondary parcel specific information 232 associated with a respective parcel.

At 414, the retrieved primary data 216, the retrieved tagged secondary parcel specific information 222 and the retrieved untagged secondary parcel specific information 232 associated with a respective parcel is presented in a tabbed user interface format 202 such as that discussed in detail with regard to FIG. 2. In the tabbed user interface format 202, all of the tabs 212 include information associated with a single parcel.

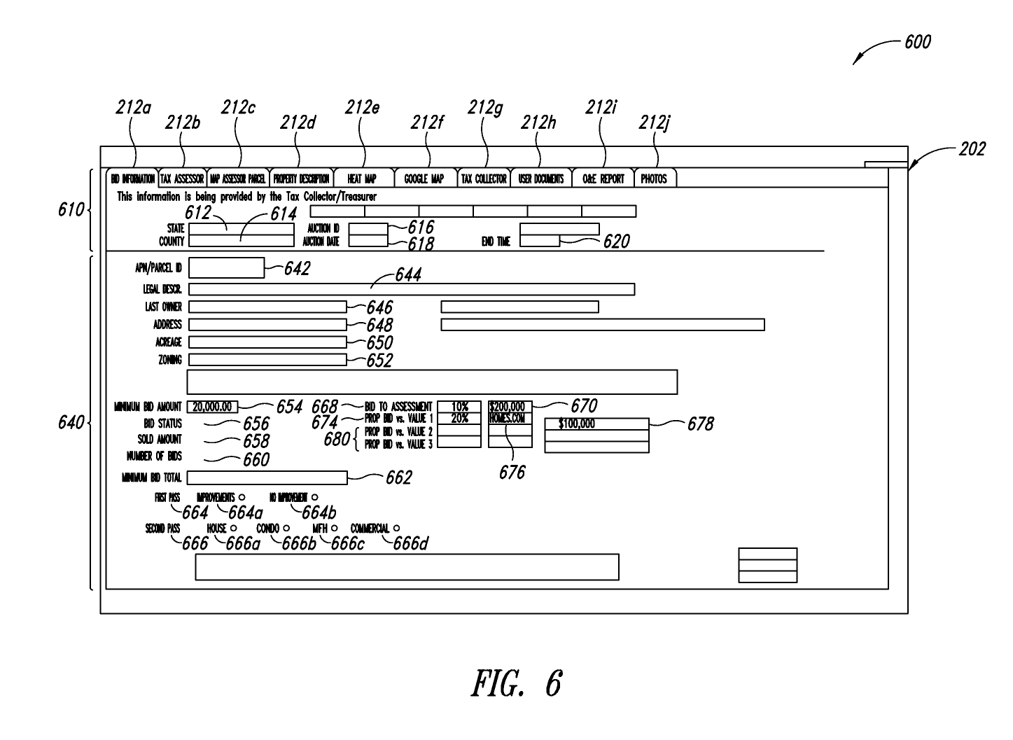

FIGS. 6 through 11 provide illustrative examples of the user interfaces provided by various tabs in the tabbed user interface 202 provided at 414. FIG. 6 shows a screen capture of an illustrative Bid Information tab data screen 600. The tabbed user interface 202 shown in FIG. 6 contains a total of fifteen visible tabs 212a-212o. The Bid Information tab includes a first section 610 that includes information associated with a real property auction event and a second section 640 that includes information related to a parcel offered for sale at the real property auction event. The first section 610 includes a state field 612 and a county field 614 that identifying the state and county holding the real property auction event. Also included in the first section are an auction ID field 616, an Auction Date field 618, and an Auction End Time field 620.

The second section 640 includes primary parcel specific information 216, tagged secondary parcel specific information 222, and untagged secondary parcel specific information 232. Importantly, the primary parcel specific identifier 204 appears in the APN/Parcel ID field 642. The primary parcel specific identifier 204 logically associates or links all of the data included on each tab 212 to a single parcel offered for sale at a real property auction event. Additional data fields include a Legal Description field 644; an Address field 648; an Acreage field 650; and a Zoning field 652.

The second section 640 may also include information regarding the bidding process for the respective parcel. For example, the second section 640 may include a Minimum Bid Amount field 654; a Bid Status field 656; a Sold Amount field 658; a Number of Bids field 660; a Minimum Bid Total field (the total of all minimum bid amounts for all parcels offered at a single auction event) 662. Since some auction events may include a large number of parcels, the second section 640 may include one or more filters to limit the number of parcels presented to the data consumer 130 to those meeting one or more defined criteria. For example, a First Pass filter 664 may include radio buttons or similar selectable icons to filter results by those parcels with improvements 664a and those parcels without improvements 664b. In another example, a Second Pass filter 666 may include radio buttons or similar selectable icons to filter results by parcels with a house 666a; parcels with a condominium 666b; parcels with a multi-family residence 666c; parcels with commercial structures 666d; parcels containing land 666e; and parcels meeting other defined criteria 666f.

The second section 640 may also include analysis information associated with the respective parcel. For example, the second section may include an assessed value 670 provided, for example, by a jurisdictional tax assessor. Also included in the second section 640 is a Bid to Assessment ratio field 668 in which the ratio of the minimum bid amount to the assessed value is expressed as a percentage. Also included in the second section 640 ratios based on other assessed values, for example assessed values provided by real estate Websites such as Homes.com and Zillow.com. The Prop Bid vs. Value field 674 includes a ratio of the minimum bid amount to a value provided in field 678 by the source listed infield 676. Similar Prop Bid vs. Value information may be sourced from any number of other Websites and displayed in fields 680.

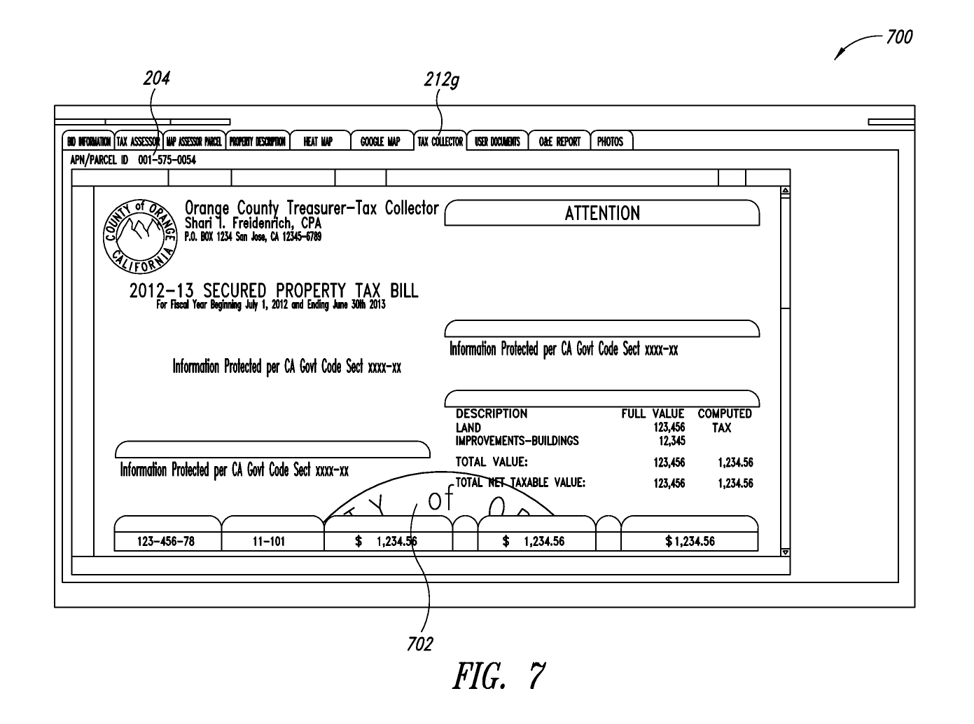

FIG. 7 shows a screen capture of an illustrative Tax Collector tab 212g user interface 700. The user interface 700 includes an image of the most recent tax bill 702 associated with the parcel identified by the primary parcel specific identifier 204 is provided. Using the property tax bill for a parcel, an investor can determine the outstanding obligations due on the property as well as prior assessments and taxes paid on the property.

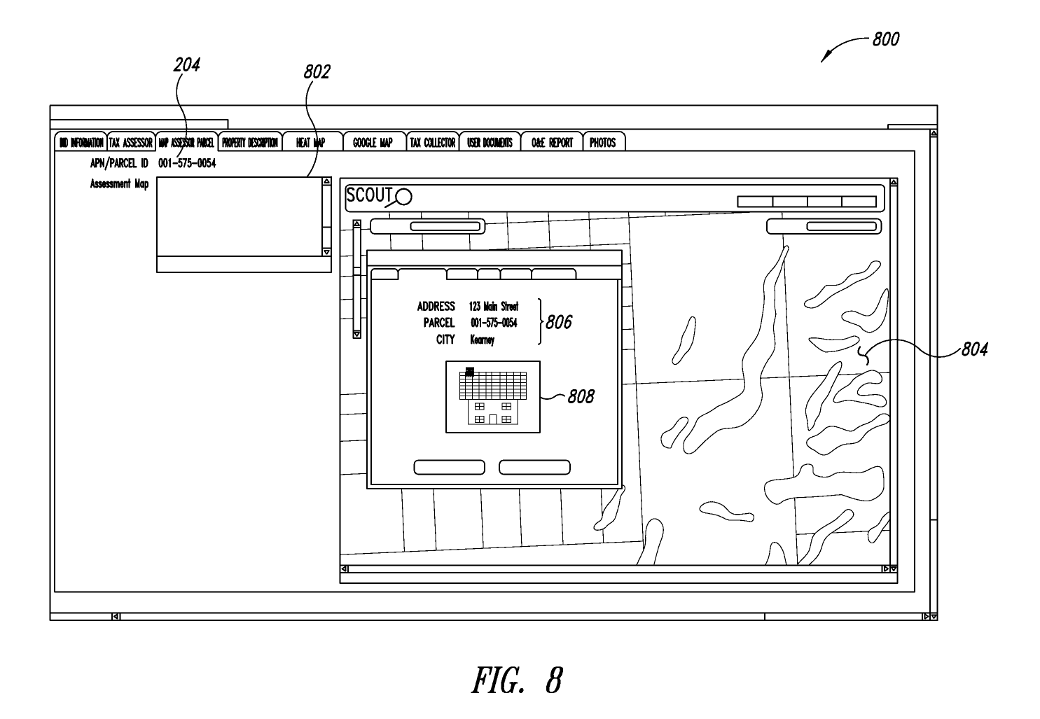

FIG. 8 shows a screen capture of an illustrative APN Map tab 212c user interface 800. The user interface 800 includes a graphic of the assessment map 802 associated with the parcel identified by the primary parcel specific identifier 204. Also displayed is a larger parcel map graphic 804 and a pop-up window providing parcel data 806 and an image of the property 808 on file with the tax assessor's office.

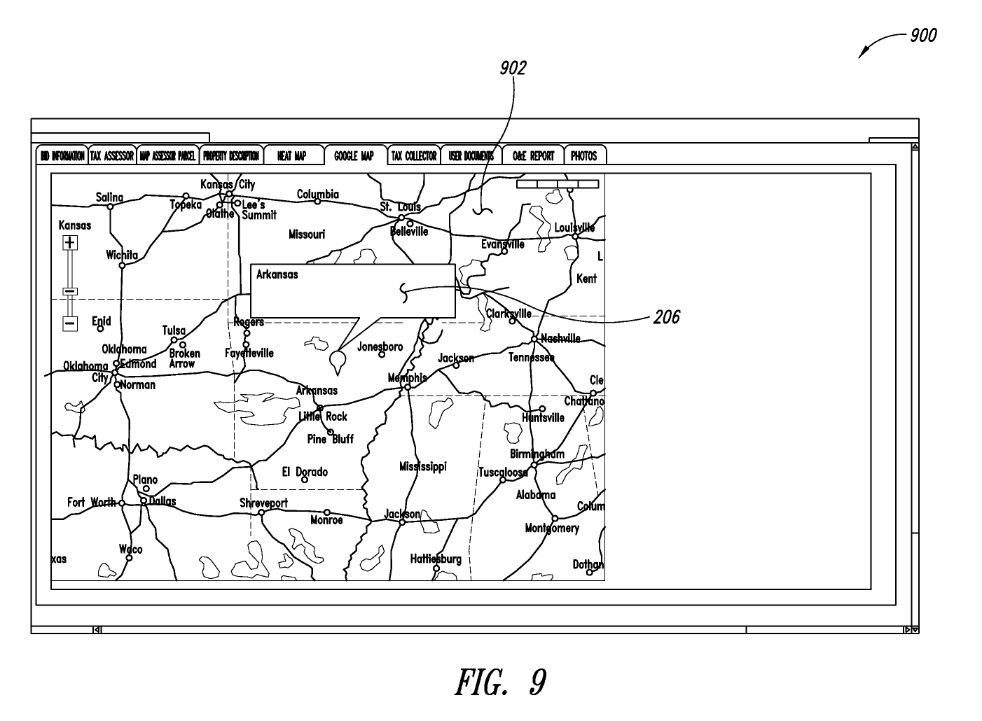

FIG. 9 shows a screen capture of an illustrative Google Map tab 212f user interface 900. The user interface 900 includes a graphic of the Google Map 902 associated with the parcel identified using a secondary parcel specific identifier 206.

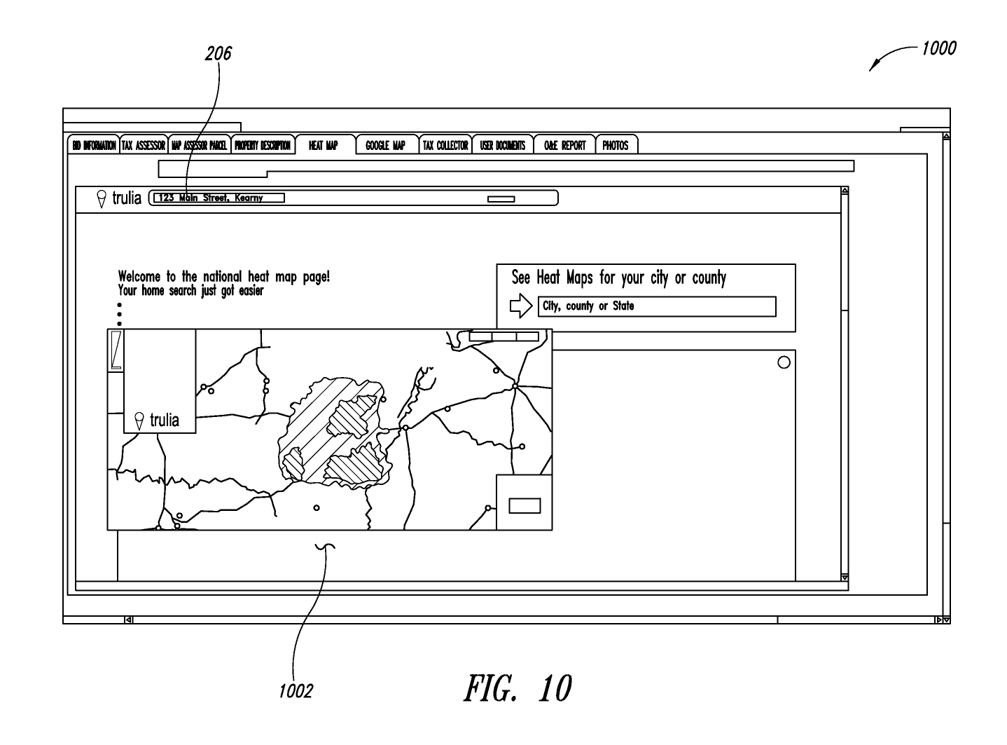

FIG. 10 shows screen capture of an illustrative Heat Map tab 212e user interface 1000. The user interface 1000 includes a graphic of a real property heat map 1002 associated with the parcel identified using a secondary parcel specific identifier 206 imported from a third party source, in this example a heat map generated by Trulia.com.

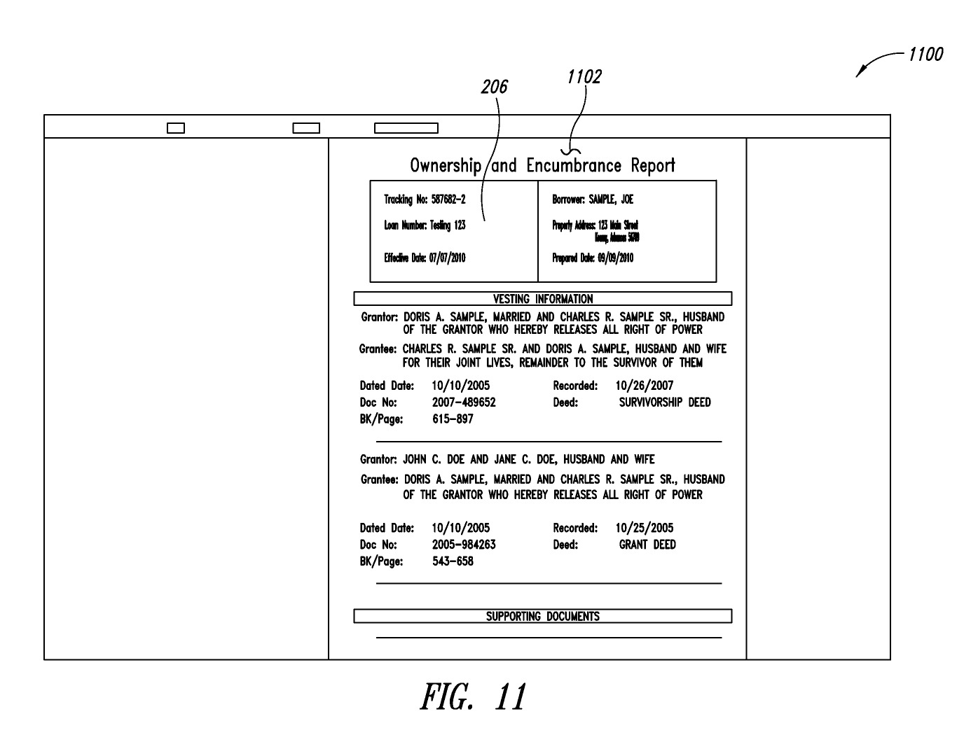

FIG. 11 shows a screen capture of an illustrative O&E Report tab 212i user interface 1100. The user interface 1100 includes a graphic of an Ownership and Encumbrance report prepared for the parcel identified using a secondary parcel specific identifier 206. In at least some implementations, a third party provider provides the O&E Report as a “for-fee” service.

Returning to FIG. 4, at 416, as an alternative to the tabbed user interface format 202, a tabular user interface format presents the retrieved primary data 216, the retrieved tagged secondary parcel specific information 222 and the retrieved untagged secondary parcel specific information 232 associated with each of a number of parcels. The tabular user interface format facilitates comparison of parcel data by the data consumer 130. In at least some instances, the data consumer is provided the ability to change between the tabbed user interface format 202 and the tabular user interface format, for example by selecting an icon present on each interface that switches between interface formats. In some instances, selecting a parcel in the tabular user interface format can transition to the tabbed user interface format 202 displaying the retrieved primary data 216, the retrieved tagged secondary parcel specific information 222 and the retrieved untagged secondary parcel specific information 232 for the parcel selected in the tabular user interface format.

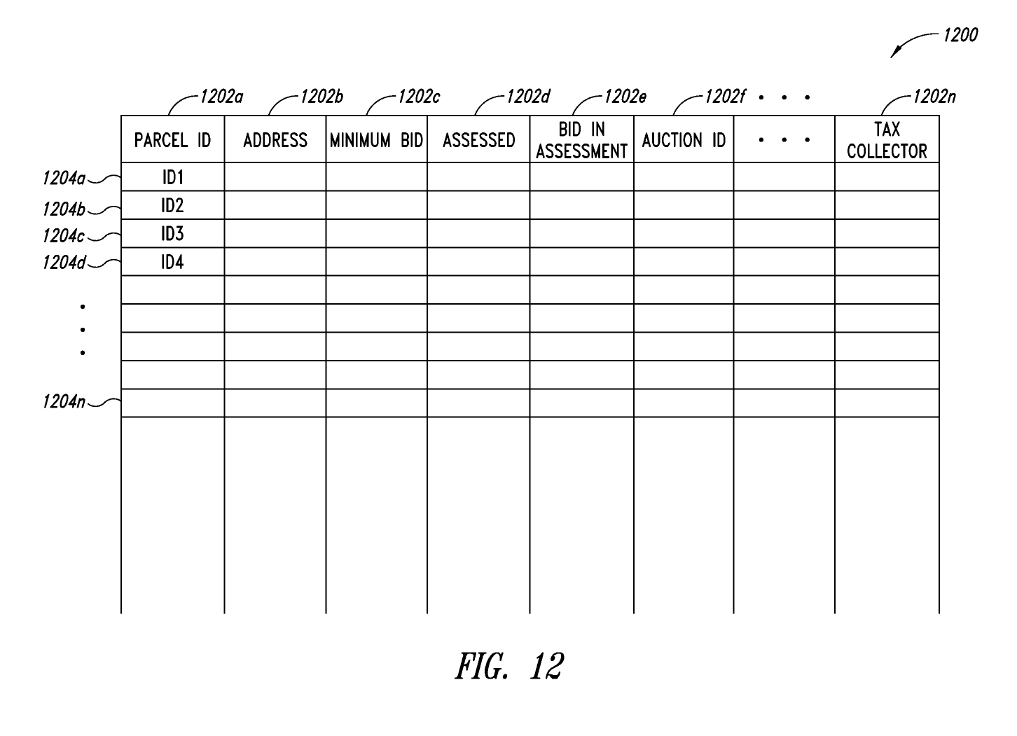

FIG. 12 illustrates an example tabular user interface format 1200. In the tabular user interface format 1200, separate columns 1202a-1202n display the retrieved primary data 216, the retrieved tagged secondary parcel specific information 222 and the retrieved untagged secondary parcel specific information 232. Similarly, separate rows 1204a-1204n each display data associated with a single parcel. In at least some instances, one or more filters may be applied to limit the data displayed in the tabular user interface format 1200. In some instances, the data consumer 130 can arrange some or all of the columns 1202a-1202n in a desired or defined order. At least some of the “cells” formed at the intersection of one or more columns and one or more rows may include one or more macros or links to external resources. For example, one or more links for ordering an Ownership & Encumbrance report may be provided. In some instances, selecting the contents of one or more columns in a particular row 1204 may transition to a tabbed user interface format 202 associated with the parcel selected in the tabular user interface format 1200.

Returning to FIG. 4, at 418 the data consumer 130 may select a parcel displayed in the tabular user interface format 1200. Responsive to the selection of the parcel, the parcel data collection and analysis system 102 can switch to a tabbed user interface format 202 that displays the data associated with the parcel selected in the tabular user interface format 1200.

At 420, the order of the columns 1202 displayed in the tabular user interface format 1200 may be customized (i.e., added, deleted, reordered) by the data consumer 130.

At 422, the parcel data collection and analysis system 102 provides the data consumer 130 with an opportunity to order optional reports. Such reports may include, but are not limited to, an Ownership & Encumbrance report associated with a particular parcel; a title search or title report associated with a particular parcel; or similar reports associated with one or more parcels offered for sale at a real property parcel auction event. The method 400 of collecting and analyzing information associated with one or more distressed real property parcels offered for sale at a real property auction event concludes at 424.

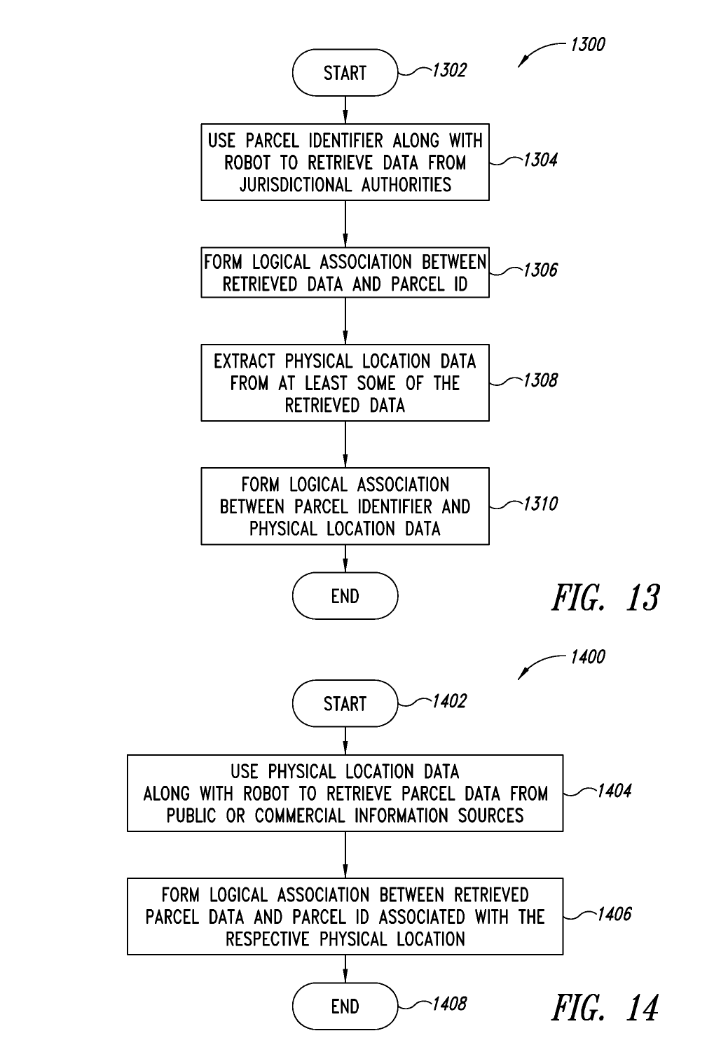

FIG. 13 shows an illustrative method 1300 of autonomously retrieving primary parcel specific information 216 from a number of primary information sources 110 using a robot or “bot,” according to one embodiment. In at least some instances, the Website providing the real property auction event data to the parcel data collection and analysis system 102 provides the parcel data collection and analysis system 102 with primary parcel specific identifiers 204 associated with each of the parcels offered for sale at the auction event. Using the provided primary parcel specific identifiers 204, a robot or similar autonomous approach can obtain additional primary parcel specific information 216 from one or more primary information sources 110, for example by providing the primary parcel specific identifier 204 to the primary information sources 110.

The parcel data collection and analysis system 102 extracts one or more secondary parcel specific identifiers 206 from the retrieved primary parcel specific information 216. The parcel data collection and analysis system 102 then logically associates the extracted one or more secondary parcel specific identifiers 206 with the respective primary parcel specific identifier 204 associated with the respective parcel and provided by the respective real property auction event data. The method 1300 of autonomously retrieving primary parcel specific information 216 from a number of primary information sources 110 using a robot commences at 1302.

At 1304, using the primary parcel specific identifiers 204 obtained from the real property parcel auction event, the parcel data collection and analysis system 102 autonomously retrieves primary parcel specific information 216 from one or more primary information sources 110 using a robot, a spider, a crawler, or similar approach. In at least some implementations, the primary parcel specific identifier 204 is a Parcel ID or similar identifier assigned to the parcel by a jurisdictional taxation authority or utility.

At 1306, the parcel data collection and analysis system 102 forms a logical association between the retrieved primary parcel specific information 216 and the primary parcel specific identifier 204 associated with the respective parcel.

At 1308, the parcel data collection and analysis system 102 extracts one or more secondary parcel specific identifiers 206 from the retrieved primary parcel specific information 216. In at least some implementations, the secondary parcel specific identifier 206 can include a physical or street address associated with the parcel or geolocation coordinates associated with the parcel.

At 1310, the parcel data collection and analysis system 102 logically associates the extracted secondary parcel specific identifiers 206 associated with a parcel with the primary parcel specific identifier 204 associated with the respective parcel. In at least some implementations, the parcel data collection and analysis system 102 forms a logical association between a Parcel ID associated with the parcel (i.e., the primary parcel specific identifier 204) and the street address or geolocation coordinates associated with the respective parcel (i.e., the secondary parcel specific identifiers 206). The method 1300 of autonomously retrieving primary parcel specific information 216 from a number of primary information sources 110 using a robot concludes at 1312.

FIG. 14 shows an illustrative method 1400 of autonomously retrieving tagged secondary parcel specific information 222 and untagged secondary parcel specific information 232 from a number of secondary information sources 120 using a robot, according to one embodiment. Using one or more extracted secondary parcel specific identifiers 206, a robot or similar autonomous construct or approach can obtain tagged secondary parcel specific information 222 and untagged secondary parcel specific information 232 from one or more secondary information sources 120, for example by providing the secondary parcel specific identifier 206 to the secondary information source 120. Because the secondary parcel specific identifiers 206 have been logically associated with the primary parcel specific identifier 204, the parcel data collection and analysis system 102 logically associates the retrieved tagged secondary parcel specific information 222 and untagged secondary parcel specific information 232 with the primary parcel specific identifier 204. The method 1400 of autonomously retrieving tagged secondary parcel specific information 222 and untagged secondary parcel specific information 232 from a number of secondary information sources 120 using a robot commences at 1402.

At 1404, using one or more secondary parcel specific identifiers 206 obtained from the primary parcel specific information 216, the parcel data collection and analysis system 102 autonomously retrieves tagged secondary parcel specific information 222 and untagged secondary parcel specific information 232 from one or more secondary information sources 120 using a robot, a spider, a crawler, or similar construct or approach. In at least some implementations, the one or more secondary parcel specific identifiers 206 can include a physical or street address associated with a particular parcel or a geolocation associated with a particular parcel.

At 1406, the parcel data collection and analysis system 102 logically associates the retrieved tagged secondary parcel specific information 222 and untagged secondary parcel specific information 232 with the primary parcel specific identifier 204. In some implementations, the parcel data collection and analysis system 102 forms a logical association between a Parcel ID associated with the parcel (i.e., the primary parcel specific identifier 204) and the retrieved tagged secondary parcel specific information 222 and untagged secondary parcel specific information 232. The method 1400 of autonomously retrieving tagged secondary parcel specific information 222 and untagged secondary parcel specific information 232 from a number of secondary information sources 120 using a robot concludes at 1408.

The above description of illustrated embodiments, including what is described in the Abstract, is not intended to be exhaustive or to limit the embodiments to the precise forms disclosed. Although specific embodiments and examples are described herein for illustrative purposes, various equivalent modifications can be made without departing from the spirit and scope of the disclosure, as will be recognized by those skilled in the relevant art. The teachings provided herein of the various embodiments can be applied to other systems, not necessarily the exemplary communication service provider systems generally described above.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of non-transitory signal bearing media include, but are not limited to, the following: recordable type media such as floppy disks, hard disk drives, CD ROMs, digital tape, and computer memory; and other non-transitory computer-readable storage media.

The various embodiments described above can be combined to provide further embodiments. To the extent that they are not inconsistent with the specific teachings and definitions herein, all of the U.S. patents, U.S. patent application publications, U.S. patent applications, foreign patents, foreign patent applications and non-patent publications referred to in this specification and/or listed in the Application Data Sheet, including but not limited to U.S. Provisional Patent Ser. No.: 61/924,118, filed Jan. 6, 2014.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of retrieving and analyzing parcel data from a collection of data sources and associated with parcels offered at a number of auction events, the method comprising:
autonomously retrieving by at least one processor a number of unique primary identifiers, each logically associated with a parcel offered for purchase at an auction event and located in a defined geographic jurisdiction;
for each of the number of primary identifiers retrieved by the at least one processor, autonomously retrieving by the at least one processor primary parcel specific information from a number of networked primary data sources, each of the number of networked primary data sources including primary parcel specific information associated with the respective parcel; and
storing the retrieved primary parcel specific information in one or more data stores included in at least one nontransitory storage media communicably coupled to the at least one processor, the retrieved primary parcel specific information logically associated with a single parcel indexed across the one or more data stores using the primary identifier associated with the respective parcel.

2. The method of claim 1 wherein autonomously retrieving by at least one processor a number of unique primary identifiers comprises:
receiving by the at least one processor via a communicably coupled input device at least one input indicative of a selection of the auction event;
responsive to the receipt of the input indicative of the selection of the auction event, autonomously retrieving by the at least one processor the number of unique primary identifiers, each of the number of unique primary identifiers logically associated with respective parcels offered for purchase at the selected auction event and located in the defined geographic jurisdiction.

3. The method of claim 2 wherein receiving by the at least one processor at least one input indicative of a selection of the auction event comprises:
receiving by the at least one processor via a communicably coupled input device at least one input that includes data indicative of a selection of at least one auction event via a graphical user interface that includes at least a calendar on which the auction events are displayed.

4. The method of claim 3 wherein receiving by the at least one processor at least one input that includes data indicative of a selection of at least one auction event presented on a calendar graphical user interface comprises:
receiving by the at least one processor at least one input that includes data indicative of a selection of at least one distressed real property parcel auction event displayed via the graphical user interface that includes at least a calendar.

5. The method of claim 1 wherein autonomously retrieving by the at least one processor a number of unique primary identifiers, each logically associated with a parcel offered for purchase at the selected auction event comprises:
autonomously retrieving by the at least one processor a number of unique real property parcel identifiers (“parcel IDs”), each logically associated with a distressed real property parcel offered for purchase at the auction event.

6. The method of claim 5 wherein autonomously retrieving by the at least one processor primary parcel specific information from a number of networked primary data sources comprises:
autonomously retrieving by the at least one processor primary parcel specific information from a number of networked primary data sources, the number of networked primary data sources including at least one of a source administered by: a Mortgage Electronic Records System (“MERS”); a Federal Emergency Management Authority (“FEMA”); a tax assessor for the geographical jurisdiction; or a tax collector for the geographical jurisdiction.

7. The method of claim 6 wherein autonomously retrieving by the at least one processor primary parcel specific information from a number of primary data sources comprises:
autonomously retrieving by the at least one processor primary parcel specific information from the number of primary data sources, the primary parcel specific information including at least one of: an assessed parcel land value; an assessed parcel improvements value; the date and/or amount of prior taxes paid on the parcel; or the date and/or amount of current taxes due on the parcel.

8. The method of claim 1, further comprising:
for each of at least some of the number of primary identifiers retrieved by the at least one processor, autonomously retrieving by the at least one processor at least one secondary identifier associated with the respective parcel from at least one of the number of networked primary data sources;
for each of the number of secondary identifiers retrieved by the at least one processor, autonomously retrieving by the at least one processor secondary parcel specific information from a number of networked secondary data sources, each of the number of networked secondary data sources including at least secondary parcel specific information associated with the respective parcel; and
storing in at least one nontransitory storage media communicably coupled to the at least one processor the retrieved secondary parcel specific information, the retrieved secondary parcel specific information logically associated with the primary identifier associated with the respective parcel.

9. The method of claim 8 wherein autonomously retrieving by the at least one processor at least one secondary identifier logically associated with the respective parcel from at least one of the number of networked primary data sources comprises:
autonomously retrieving by the at least one processor at least one secondary identifier representative of at least one of: a street address logically associated with the parcel or a unique set of geolocation coordinates logically associated with the parcel from at least one of the number of primary data sources.

10. The method of claim 8 wherein autonomously retrieving by the at least one processor secondary parcel specific information from a number of networked secondary data sources comprises:
autonomously retrieving by the at least one processor secondary parcel specific information from a number of networked secondary data sources including at least one Website.

11. The method of claim 8 wherein autonomously retrieving by the at least one processor secondary parcel specific information from a number of networked secondary data sources comprises:
autonomously retrieving by the at least one processor secondary parcel specific information that includes at least one of: comparable parcel sales, a real-estate heat map, estimated parcel values, parcel owner information, parcel rental income potential, or prior parcel sale information.

12. A system of retrieving parcel data from a collection of data sources and related to parcels offered at a number of auction events, the system comprising:
at least one processor;
at least one user input device communicably coupled to the at least one processor;
at least one user output device communicably coupled to the at least one processor; and
at least one nontransitory storage media communicably coupled to the at least one processor and including one or more machine executable instruction sets that, when executed by the at least one processor, provide a dedicated parcel auction analysis and reporting system and which cause the at least one processor to:
autonomously retrieve a number of unique primary identifiers, each associated with a parcel offered for purchase at an auction event and located in a defined geographic jurisdiction;
for each of the number of unique primary identifiers, autonomously retrieve from a number of network primary data sources primary parcel specific information associated with the respective unique primary identifier; and
store the retrieved primary parcel specific information in one or more data stores included in the at least one nontransitory storage media, the retrieved primary parcel specific information associated with a parcel indexed across the one or more data stores using the primary identifier logically associated with the respective parcel.

13. The system of claim 12 wherein the one or more machine executable instruction sets that cause the at least one processor to autonomously retrieve a number of unique primary identifiers further cause the at least one processor to:
receive at least one input indicative of a selection of the auction event via the at least one input device;
responsive to the receipt of the input provided via the at least one input device, autonomously retrieve the number of unique primary identifiers, each of the number of unique primary identifiers associated with a parcel offered for purchase at an auction event and located in a defined geographic jurisdiction.

14. The system of claim 13 wherein the one or more machine executable instruction sets that cause the at least one processor to receive at least one input indicative of a selection of the auction event via the at least one input device further cause the at least one processor to:
cause the processor to generate data representative of an output for presentation on the at least one communicably coupled output device, the data representative of the output including a graphical user interface that includes at least a calendar on which the auction events are displayed; and
receive via the calendar displayed on the graphical user interface the at least one input indicative of a selection of the auction event.

15. The system of claim 14 wherein the one or more machine executable instruction sets that cause the at least one processor to generate data representative of an output for presentation by the at least one communicably coupled output device, further cause the at least one processor to:
generate data representative of an output for presentation by the at least one communicably coupled output device, the data representative of the output including at least a graphical user interface that includes at least a calendar on which a number of distressed parcel auction events are displayed.

16. The system of claim 15 wherein the one or more machine executable instruction sets that cause the at least one processor to autonomously retrieve a number of unique primary identifiers, each of the unique primary identifiers associated with a parcel offered for purchase at an auction event, further cause the at least one processor to:
autonomously retrieve a number of unique parcel identifiers (“parcel IDs”), each of the parcel IDs associated with a distressed real property parcel offered for purchase at one of the number of distressed parcel auction events.

17. The system of claim 12 wherein the one or more machine executable instruction sets that cause the at least one processor to autonomously retrieve from a number of network primary data sources primary parcel specific information associated with the respective primary identifier further cause the at least one processor to:
for each primary identifier, autonomously retrieve primary parcel specific information associated with the respective primary identifier from the number of network primary data sources including at least one of a source administered by: a Mortgage Electronic Records System (“MERS”); a Federal Emergency Management Authority (“FEMA”); a tax assessor for the geographical jurisdiction; or a tax collector for the geographical jurisdiction.

18. The system of claim 12 wherein the one or more machine executable instruction sets that cause the at least one processor to autonomously retrieve from a number of network primary data sources primary parcel specific information associated with the respective primary identifier further cause the at least one processor to:
autonomously retrieve from a number of primary data sources primary parcel specific information including at least one of: an assessed parcel land value; an assessed parcel improvements value; the date and/or amount of prior taxes paid on the parcel; or the date and/or amount of current taxes due on the parcel.

19. The system of claim 12, wherein the one or more machine executable instruction sets further cause the at least one processor to:
autonomously identify at least one secondary identifier included in the primary parcel specific information retrieved from the number of network primary data sources using at least some of the number of primary identifiers;
logically associate the at least one secondary identifier with the respective primary identifier associated with the primary parcel specific information;
for each secondary identifier, autonomously retrieve secondary parcel specific information from some or all of a number of network secondary data sources; and
storing in the at least one nontransitory storage media the retrieved secondary parcel specific information, the stored secondary parcel specific information logically associated with the respective primary identifier associated with the primary parcel specific information.

20. The system of claim 19 wherein the one or more machine executable instruction sets that cause the at least one processor to autonomously identify at least one secondary identifier included in the primary parcel specific information retrieved from the number of network primary data sources, further cause the at least one processor to:
autonomously identify at least one secondary identifier included in the primary parcel specific information retrieved from the number of network primary data sources, the at least one secondary identifier including data representative of at least one of: a street address associated with the parcel or a unique set of geolocation coordinates associated with the parcel.

21-50. (canceled)
